(19) United States
(12) Patent Application Publication
(10) Pub. No.: US 2012/0259669 A1
(43) Pub. Date: Oct. 11, 2012

(54) SYSTEM AND METHOD OF GENERATING INTERACTIVE DIGITAL MAPPING INTEGRATION OF TRAVEL PLANS

(76) Inventors: Vern L. Stilwell, Kansas City, MO (US); Gupta V. Darisi, Fenton, MO (US)

(21) Appl. No.: 13/442,731

(22) Filed: Apr. 9, 2012

Related U.S. Application Data
(60) Provisional application No. 61/473,511, filed on Apr. 8, 2011.

(51) Int. Cl. G06Q 10/02

(52) U.S. Cl. 705/5

(57) ABSTRACT

A system and process for the selection, distribution, and display of travel information. Flight or other travel data is disseminated from an administrative “back end” system to a mobile personal computing device. Flights and ancillary services such as car rentals and hotel rooms may be booked directly from said mobile computing device. The system and process allows flight data to be selected based upon destination, flight origin, airline, and flight path. An interactive map allows users to quickly and easily plan routes or alter travel plans on the go.

### CROSS-REFERENCE TO RELATED APPLICATION

This application claims priority in U.S. Provisional Patent Application No. 61473,511, filed Apr. 8, 2011, which is incorporated herein by reference.

### BACKGROUND OF INVENTION

1. Field of the Invention

The present invention relates generally to a system and process for generating travel information, and more specifically to a new and improved system and process for the selection, distribution, and display of travel information, which provides a data input application—the administrative “back end” system—which allows the addition of travel data such as airlines, cruise lines and railroads, Geographic Information System (GIS) latitude-longitude data and any other data useful for the system, and a customer interface “front-end” system in order to generate dynamic, carrier integrated mapped routes, with the information being displayed on a dynamic and interactive digital map.

Visual orientation on a digital map, which will orient the traveler, is preferable to no visual representation. Generally accepted principles of learning and memory retention prove that “illustrations are superior to text when learning spatial information . . . route information was learned more quickly when using a map,” as compared to lists. “Maps were superior to lists.” “When performing a spatial task, use of maps is superior to lists because the map presentation of information is consistent with peoples' preferred internal representation of spatial information.” Therefore, it is beneficial to the travel experience when routing is provided on a map, with additional information which supports and/or supplements the graphically displayed map.

2. Description of the Related Art

Dynamic (frequently changing) travel schedules displayed on a digital map for reservation purposes are currently not available to agencies or travelers. Current publicly available digital map capabilities provide the ability to track ground-based travel using “highway or street” routes between two points without consideration for meeting any particular schedule, with regard to date or time of travel departure or arrival. Typically “highway or street” routes follow along one or more paths, pre-determined by the highway or street mapped computer system, based on user input coordinate locations. In addition, written directions, “left/right turn,” may be associated with the display. These ground-based routing presentations do not provide dynamic, schedule-based or integrated routing with any other types of scheduled public or private conveyances displayed on the map.

Travel planning and searching for travel are distinctly different activities as compared to fulfilling the ordering and booking of travel—Related to on-line or telephonic travel arrangements, there may be over 1,000 requests for travel searches for every ticket reserved. With thousands of tickets being reserved, the number of searches to create an itinerary at any time may require significant computing resources compared to the actual fulfillment or booking of a ticket. In order to relieve stress on various reservation systems, including airline, car rental, hotel and other fulfillment/booking systems, it may be beneficial to provide a separate system for limiting or allowing the user to pre-search for the traveler's desired route, utilizing display of the itinerary and route on the interactive digital map, prior to submission to the associated reservation source. Through the use of the present invention, the creation of the itinerary and its subsequent submission to the fulfillment/booking system would result in a significant decrease or elimination of time spent in searches, as compared to actually booking a reservation, thereby providing a more efficient and cost effective method of booking travel.

Current travel route-maps do not provide multiple-carrier integrated and dynamic schedule-based routes for the traveler. Some travel carrier websites provide a graphical display of a static (or “flash”) route map but in many instances the map is outdated or limited to the specific carrier and the routes are not integrated with any other carrier type (air, cruise-line, railroad). In addition, some travel carrier maps limit the displayed information to a specific route without regard to potentially dynamic changes near real time, which may render the map outdated prior to the map being published. Some other systems providing a travel-related search engine do not provide an integrated point-to-multi-point interactive digital map of traveled routes along with information specific to the trip route. The routes must be flexible enough to include one-way, round-trip, non-stop, one or more stops and codesharing. Therefore, it would be beneficial to provide a multi-carrier, dynamic interactive digital map which may allow for the display of various routes showing point-to-multipoint routes and their connections between multiple carriers. In addition, it may be beneficial to display integrated ground-based location information associated to the connected displayed routes.

Leisure versus business travel is not adequately distinguished within systems. Generally, there are two types of travel users: business travelers and consumer travelers. Business travelers (managed business/corporate travel) wanting to display routing information on a interactive dynamic digital map who want to match proposed itineraries, schedules, carriers or travel routes with the desires of the business, the actual time it takes to travel a route being of equal importance as the travel destination. There may also be a desire on the part of businesses to limit routes which are not desirable, i.e. to reduce the availability of information and hence limit the displayed map capabilities. Additionally or alternatively, the business may desire to limit features available to their employees in some predetermined manner. Consumer travelers (unmanaged or leisure travel) which will arrange travel plans to various destinations based upon the destination features, many times the time of travel being less of a consideration when compared to the business traveler. In addition, in many instances the leisure traveler is more price sensitive and holds little brand loyalty as compared to the corporate traveler.

Training travel agency users of current Reservation Systems is very intensive, sometimes taking as long as nine months to complete. Generally, travel agencies and their agents use global distribution systems which are difficult and time consuming to learn. Understanding the difficulties that travel presents by a customer relations system results in months of training in order to understand the way the system works. Our system converts the same data used by any distribution system into a visual picture so that the user can readily “see” the creation of the travel plan on a digital map. There are no “hieroglyphs” and the user of our system doesn't have to “think like the machine” entering requests into a command-line interface. Instead, we allow the travel agency to create travel plans for customers using a map, which understands going places, instead of memorization of a reservation system and its nuances.

Travel analytics are enhanced using our system. Typical website recordings of how often people visit the site, search terms, keywords used and traffic sources provide traffic analytics but not necessarily that for which the user was actually looking By providing analytics based on where, when and what travelers searched for, in conjunction with information about what they actually purchased, we get a complete picture from planning the trip to its booking.

Travelers can navigate without a keyboard. The future is now: pads, tablets, slates, Internet TV, Nintendo Wii, touch and go, or click and go, it's a traveler's choice. “The consumption of travel is going to be increasingly through the iPhone or iPad, or some device that has yet to be dreamed up,” said Zalles. “Panel members agreed that retailers in other sectors had to ensure they could sell through the devices of Apple and other suppliers, and said airlines and hotels could have to follow suit.”

Numerous device types complicate the delivery of information. Smart phones (phones with graphic display capabilities), tablets, slates, pads, netbooks, notebooks, laptops and desktop computers, all with various form factors (styles) and operating systems (to include touch and/or voice capabilities) result in problems of creating and maintaining economical software functionality for multiple versions of existing and future device types. As only one example, “Hallmark Cards Inc. has notified its staff and mobile phone users that its “mobile greetings” application will be discontinued Dec. 31. The app, introduced in mid-2009, allowed users to download and send to cell phones 99-cent greeting cards selected from an online catalog. But the company indicated that complex technical challenges came from working with as many as 18 U.S. wireless carriers and dozens of different phone models.”

Future cloud computing—Cloud computer considerations also involve moving much of a device based operating system into a “cloud computing” environment, wherein the operating system and software content may not actually be installed on the device, but rather, exist on servers connected to the internet. In this event the device becomes a thin client conduit providing limited or no “stand-alone” capabilities when not connected to the internet. The cloud will redefine access and security for users. “Function follows Form,” meaning that we know that things are changing fast and that new functionality dictates what the device looks like and its usability.

Heretofore, there exists a need for an improved system and process which provides an interactive point-to-multipoint digital map for displaying retrieved information and the ability to book the travel while using the interactive digital map, such as Google Maps, however, other digital maps may be considered.

### SUMMARY OF THE INVENTION

The present invention is generally divided into two main areas, an administrative “back-end” Marked GIS Distribution System (MGDS) for use by various persons or entities familiar with travel planning and reservations, and a customer interface “front-end” interface providing digitally-mapped displays. The administrative interface allows a user to create, read, update or delete the underlying textual database information necessary to create the point-to-multipoint routes as shown on the interactive digital map, which includes the following administrative pages: Countries, Cities, Carriers, Facilities, Destinations, Connections, Codesharing, Routes, and Schedules/Pricing. These administrative pages follow this sequence and process, and contain unique business methods and rules which facilitate building the routes with the least possible amount of data. The building of the routes may also occur where “reverse engineering” the third party schedule and fare information connects the routes, or where “xml” computer data feeds provide data into this process.

Additional administrative system functions provide connectivity to the digital map “translation services” Application Programming Interface (API) and one or more 3^{rd} party Customer Reservation Systems (CRS).

The customer interface acts as the “front-end” to the administrative interface providing visual display of the routes to multiple types of users using differing types of devices retrieving necessary travel information selected by the user. Using the customer interface, the users can “Plan and Book a Trip,” view “Route Promotions,” view “Carrier Route Networks,” create their own “Route Preferences” and other operations available while using the digital map.

A unique method and process of assembling travel carriers (herein using airlines as an example but not limited to any particular type of carrier), along with their specific carrier routing data, renders the frequently changed information to a digital map. The traveler uses the digital map displays rather than solely relying on textual information to create and book travel plans. The present system is divided into several component parts working together in tandem

### BRIEF DESCRIPTION OF THE DRAWINGS

The drawings constitute a part of this specification and include exemplary embodiments of the present invention illustrating various objects and features thereof.

FIG. 1 is a flow chart diagram showing the various steps and components necessary to practice an embodiment of the present invention.

FIG. 2 is a diagram showing the relationship among various elements necessary to practice an embodiment of the present invention.

FIG. 3 demonstrates a number of diagrams representing travel patterns as lines and curves.

FIG. 4 is a chart diagramming a component necessary to practice an embodiment of the present invention.

FIG. 5 is a chart diagramming a component necessary to practice an embodiment of the present invention.

FIG. 6 is a chart diagramming a component necessary to practice an embodiment of the present invention.

FIG. 7 is a chart diagramming a component necessary to practice an embodiment of the present invention.

FIG. 8 is a chart diagramming a component necessary to practice an embodiment of the present invention.

FIG. 9 is a chart diagramming a component necessary to practice an embodiment of the present invention.

FIG. 10 is a map representing a sample of an output from an embodiment of the present invention.

FIG. 11 is a map representing a sample of an output from an embodiment of the present invention.

FIG. 12a is a chart diagramming a component necessary to practice an embodiment of the present invention.

FIG. 12b is a continuation of the same.

FIG. 13 is a chart diagramming a component necessary to practice an embodiment of the present invention.

FIG. 14 is a map representing a sample of an output from an embodiment of the present invention.

FIG. 15 is a map representing a sample of an output from an embodiment of the present invention.

FIG. 16 displays several maps representing how a final map output from an embodiment of the present invention is generated.

FIG. 17 is a map representing a sample of an output from an embodiment of the present invention.

FIG. 18 is a table diagramming a component necessary to practice an embodiment of the present invention.

FIG. 19 is a diagram of the interaction between several components necessary to practice an embodiment of the present invention.

FIG. 20 is a table showing sample values of an element necessary to practice an embodiment of the present invention.

FIG. 21 is a flow chart diagram showing the various steps and components necessary to practice an embodiment of the present invention.

FIG. 22 is a picture of a mobile electronic device displaying a map representing a sample of an output from an embodiment of the present invention.

FIG. 23 is a picture of a mobile electronic device displaying a map representing a sample of an output from an embodiment of the present invention.

FIG. 24 is a picture of a mobile electronic device displaying a map representing a sample of an output from an embodiment of the present invention.

FIG. 25 is a picture of a mobile electronic device displaying a map representing a sample of an output from an embodiment of the present invention.

FIG. 26 is a picture of a mobile electronic device displaying a map representing a sample of an output from an embodiment of the present invention.

FIG. 27 is a picture of a mobile electronic device displaying a map representing a sample of an output from an embodiment of the present invention.

FIG. 28 is a picture of a mobile electronic device displaying a map representing a sample of an output from an embodiment of the present invention.

FIG. 29 is a picture of a mobile electronic device displaying a map representing a sample of an output from an embodiment of the present invention.

FIG. 30 is a picture of a mobile electronic device displaying a map representing a sample of an output from an embodiment of the present invention.

FIG. 31 is a picture of a mobile electronic device displaying a map representing a sample of an output from an embodiment of the present invention.

### DETAILED DESCRIPTION OF THE PREFERRED EMBODIMENTS

As required, detailed embodiments and/or aspects of the present invention are disclosed herein; however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In order to generate millions of routes which can be mapped on a digital map, data must support recognized business standards such as ISO, IATA, ICAO and GIS codes for both carriers and locations which may be provided either by automated or manual data entry methods. The system may include a database of route information retrievably stored within a computer with a computer processor which includes country data, state/province data, city data, and facility data (airports, cruise-ports, rail stations, car rental locations, hotel locations, etc.), as well as differing carrier types (airline, cruise-line and railroad). All location-based information will also be associated to specific Geographic Information System (GIS) coordinates. The data may be matched to various travel carriers, (airlines, cruise-lines and railroads) and to various routes, which may be provided by manual data entry, from travel carriers or automated from third party data providers for use on a electronic storage device by the computer with a computer processor.

In the creation of routes displayed on a digital map, a unique business process and business rules have been established to create a hierarchy of relationships such that completion of one step in the process must occur prior to completing the next step in the process, else the system will not yield the proper results. Business rule #1: as data is input in each step in the process, dependencies are created such that the deletion of any data cannot be accomplished until the data associations are removed. Associating data in this manner creates system and process integrity.

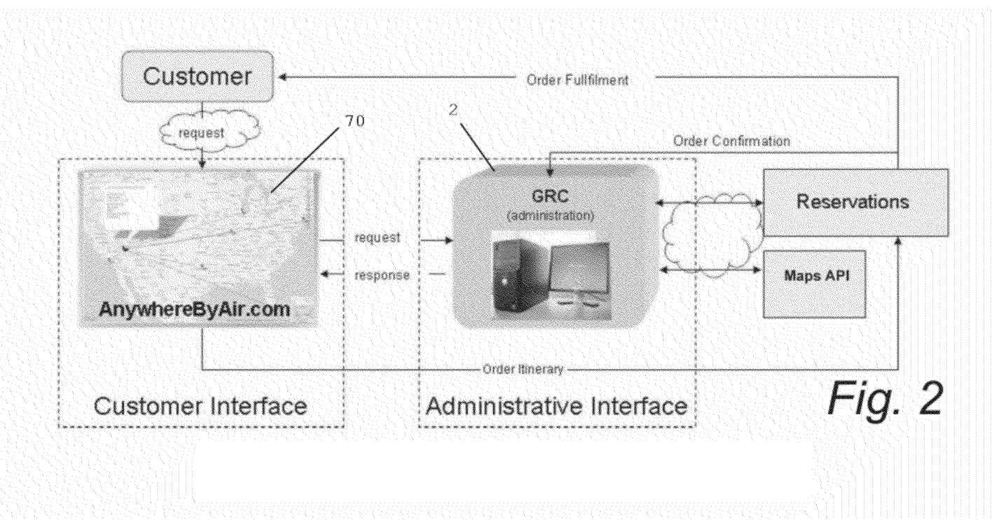

Contained within each step in the process is key business logic translated into functional design specifications which allow for real-world considerations supporting the generation of routes taking into consideration that they must: a) maintain a “From/To” direction and such “From/To” direction may be interrupted by one or more connections joining additional route possibilities, b) allow for hub and spoke routing arrangements (point-to-multipoint) in addition to “milkrun” (point-to-point) routing, c) be flexible enough to integrate carrier types such as airline, cruise-line and rail and d) be flexible enough to integrate with other carriers making allowance for codesharing/alliances where one carrier (the Affiliate) operates one or more routes for the benefit of another carrier (the Parent). FIG. 2 provides a detailed example of this.

### I. Administrative Back End System 2 for Creating and Displaying Travel Routes and Ancillary Services

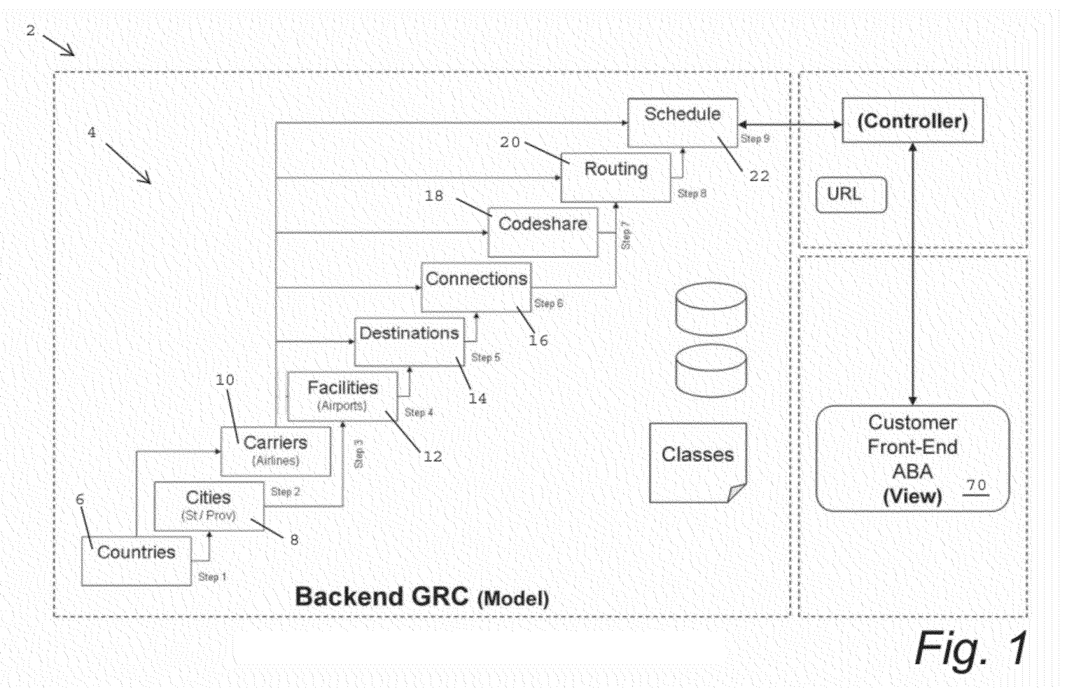

As shown in FIG. 1, a method 2 for establishing, creating, and displaying travel routes is organized into a number of Steps 4 which provide the ability to build routes and locate ancillary services. Operationally, the data is entered and a result table for each step in the process is provided for authentication and validation of the entered data. Once the routes are built, the carrier schedule/pricing information (step 9) provided by a third party may be matched to the administrative system to allow the display of scheduled routes and flights and fares. For the purpose of explanation as shown in the accompanying diagrams, reference is made to the carrier type 10 as “airline,” although for the purposes of generating routes, other carrier types, i.e., cruise-line, railroad, etc., may also be envisioned.

### II. Step 1

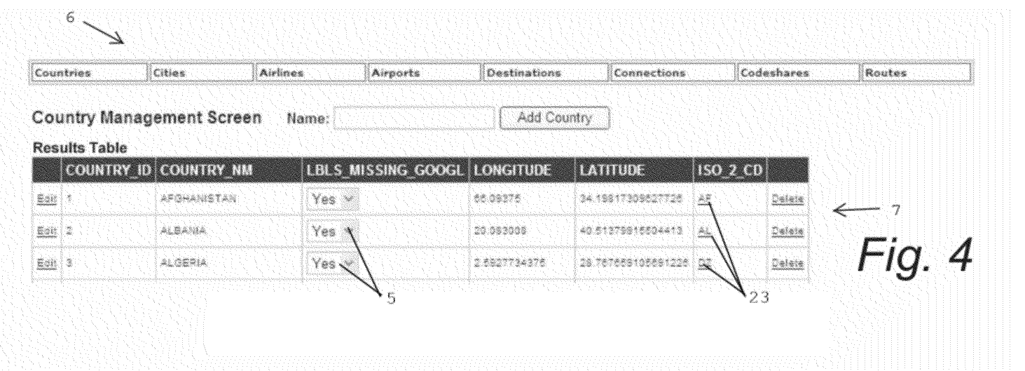

Step 1, as shown in FIG. 1 and in more detail in FIG. 4, requires the entry of country data 6 and associate ISO country code and GIS data; indicate “yes/no” if countries will include labels 5 for identification; use the country code link 23 to open a window and display the country centered on the digital map; once the country data 6 is entered and validated, the user saves the data, may review the associated results table 7, and moves to the next step.

### III. Step 2

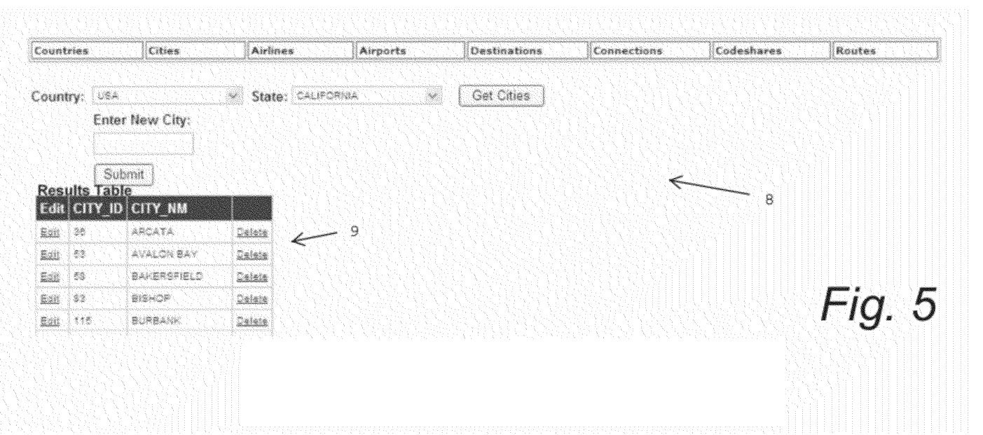

Step 2, as shown in FIG. 1 and in more detail in FIG. 5, requires the entry of city or other regional data 8 associated to a country (taking into account that two countries, USA and Canada are further divided into State or Province, respectively). Business rule #1: It may be necessary, in the instance of duplicate city, state, or region names, to assign a unique variable to each city for identification purposes. Once the city data 8 is entered and validated, the user saves the data, may review the associated results table 9 and moves to the next step.

### IV. Step 3

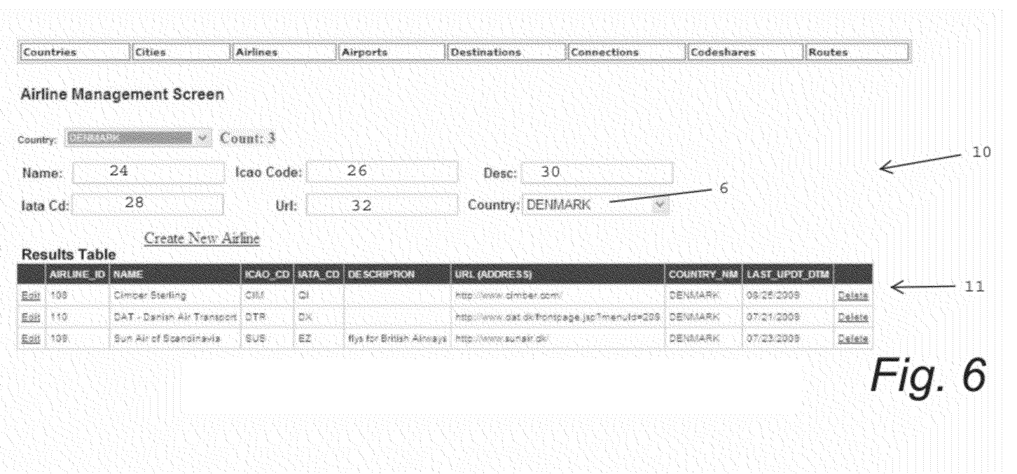

Step 3, as shown in FIG. 1 and in more detail in FIG. 6, requires the entry of carrier data 10 associated to a country 6 (where the carrier is headquartered), carrier name 24, ICAO code 26; IATA code 28; short description 30 (if needed), carrier URL 32 (external link—the carrier's publically available website) and associated country name 6. Once the carrier data is entered and validated, the user saves the data and may review the associated results table 11 and moves to the next step.

### V. Step 4

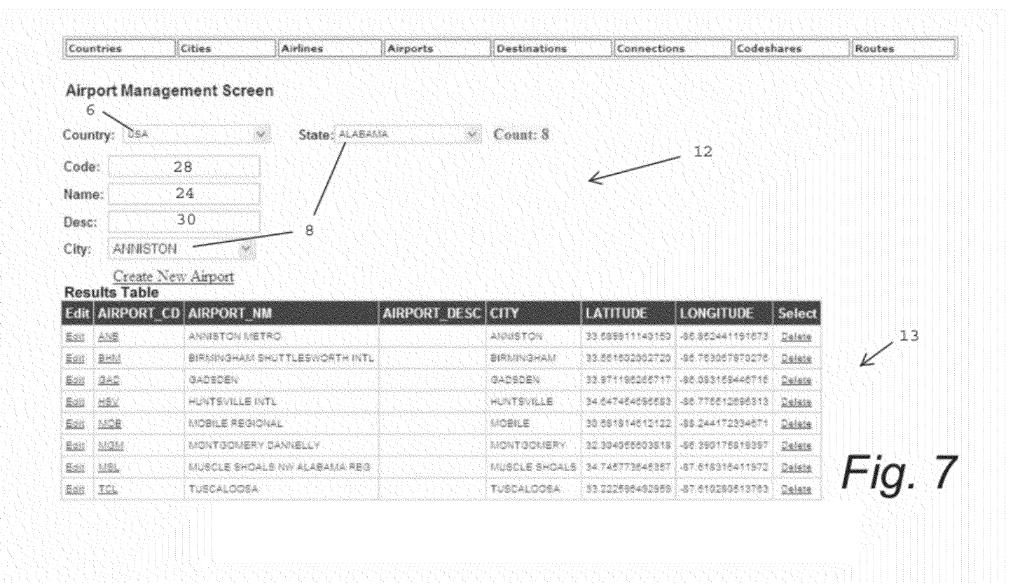

Step 4, as shown in FIG. 1 and in more detail in FIG. 7, requires the entry of facility (airports) data 12 associated to country/state 6 (for USA) or province (for Canada), IATA code 28, facility name 24, description 30, city name 8 and GIS data. Use of the IATA code 82 link will open a window and display the facility (airport) centered on the digital map. Business rule #1: there may occur instances of multiple facilities related to a single city. Once the facility data is entered and validated, the user saves the data and may review the associated results table 13 and proceeds to the next step.

### VI. Step 5

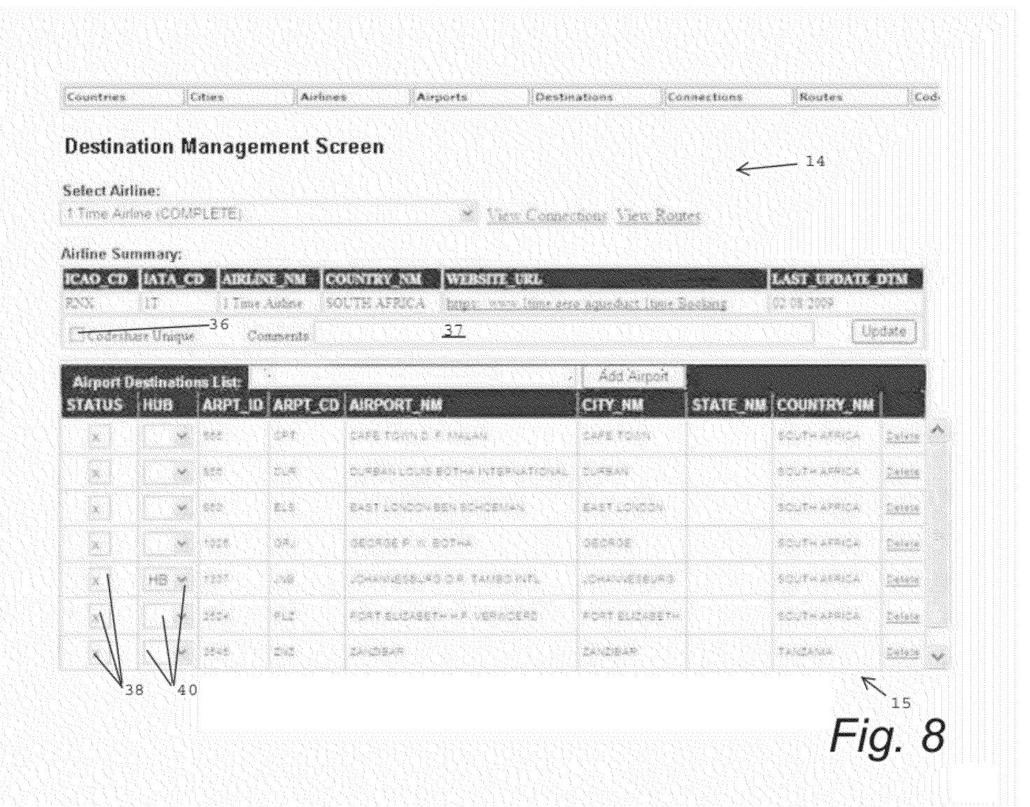

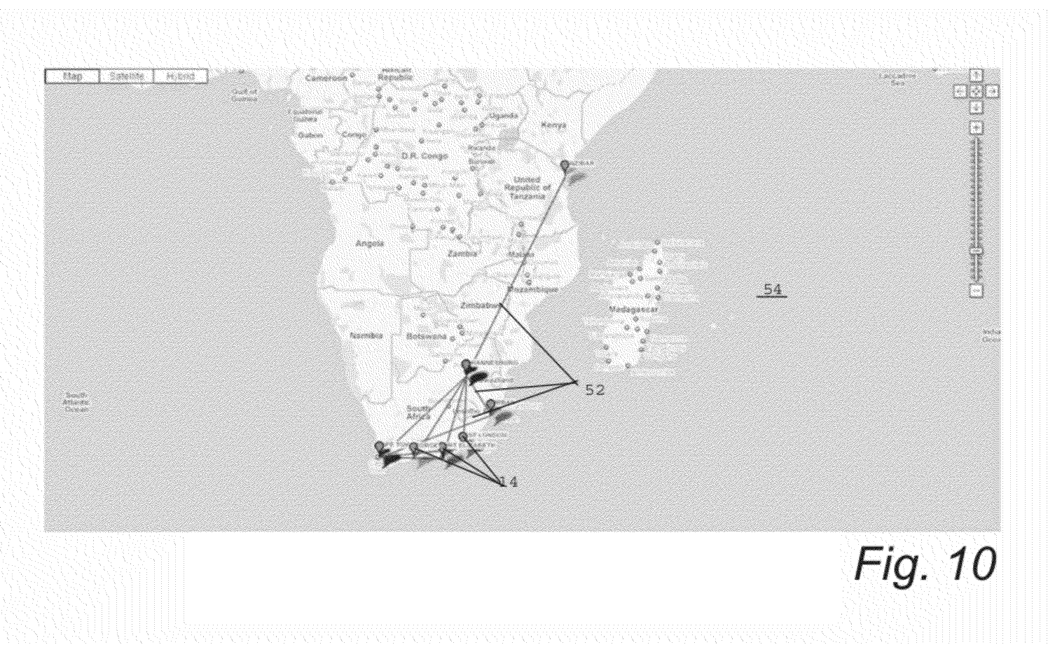

Step 5, as shown in FIG. 1 and in more detail in FIG. 8, requires the selection of destinations 14 (airports for example) associated to a carrier 10 and review current published carrier schedule information. The system 2 selects only those destinations to which the carrier will travel non-stop and does not include any other affiliate carrier information (codeshare 18 or alliance carriers) and provide comments 37 if needed. Business rule #1: exclude destinations indicated on the carrier's published schedule as “codeshare.” The allowance for codesharing occurs where one carrier, the Affiliate, operates one or more routes for the benefit of another carrier, the Parent, (codeshare Parent/Affiliate relations and their setup are detailed more fully at Step 7, FIG. 10). Business rule #2: check the “unique” checkbox 36 to indicate if the carrier is “codeshare unique.” Users cannot book flights directly with codeshare-unique carriers as they always operate for a “Parent” carrier (this rule is demonstrated in the following Codeshare-indicated logic in Step 7). Business rule #3: confirm destinations using the status checkbox 38 associated to each destination. Note: if all “status” checkboxes 38 are checked for all locations, the administrative system will indicate a “complete” status appended to the carrier name; otherwise an “incomplete” status will be appended to the carrier name. Business rule #4: for each destination, indicate whether it is a hub (from published resources), as the hub indicator 40 will help determine which destinations will be connected first as indicated by the administrative system and demonstrated at Step 6. Indication of hubs is important because of two factors: a) the user can select a hub to view multiple connected routes on the map where the entire route-map may be too large and; b) the administrative system performance of displaying the carriers' routes may necessitate viewing the smaller route groupings from the hubs. Once the destination's data is entered and validated, the user saves the data, may review the associated destinations results table 15 and moves to the next step.

### VII. Step 6

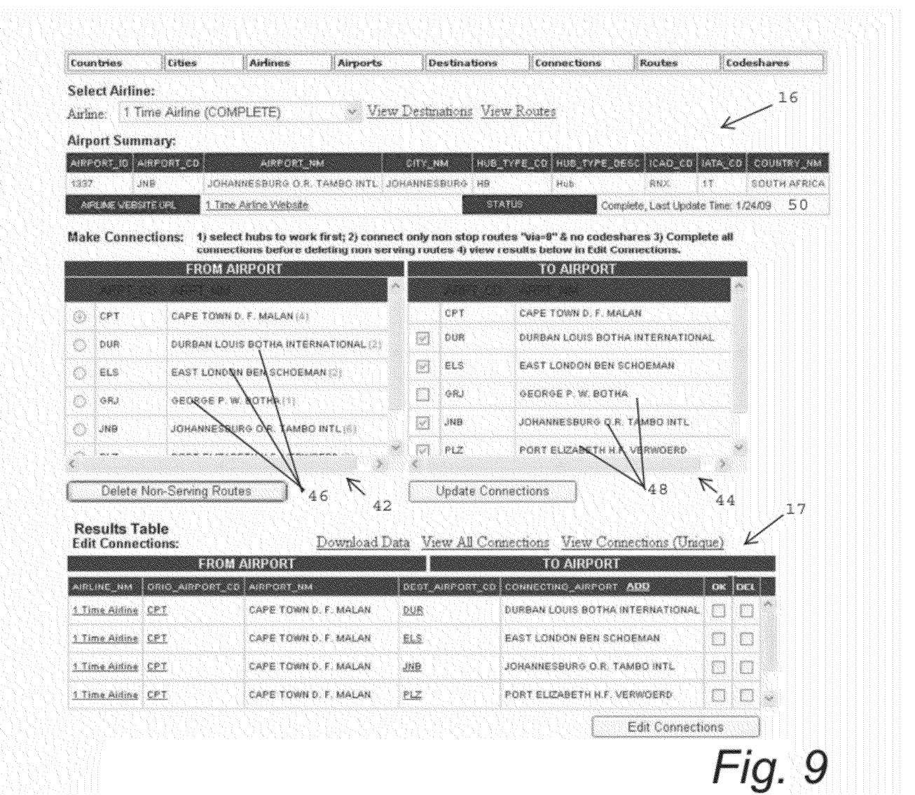

Step 6, as shown in FIG. 1 and in more detail in FIG. 9, requires the destinations results list 15 (demonstrated in step 5) to be created twice in order to make the “From/To” matches associated to a carrier. First, as a list indicating the “From” destination 42, and second, to be used as the “To” destination 44. For each carrier then, making connections 16 is the process of matching each “From” location 46 to one or more “To” locations 48. As the user makes the connections the routes are displayed in a results table 17. In addition, those destinations indicated as hubs in FIG. 8 are displayed. Since most carriers have a hub and spoke routing model (“point-to-multipoint”), it is logical to begin connecting the hub-indicated destinations first (as most of the routes will be connected at the hubs). Business rule #1: a destination 46 indicated in the “From” list 42 can only be selected once (as a radio button control) to which one or more “To” locations 48 are associated (as checkbox controls). Business rule #2: begin connecting the routes from the hub-indicated locations first because approximately sixty percent of the connections occur “at a hub.” Connect all the hub-indicated locations and then the remainder of the locations. Business rule #3: each location in the “From” list 42 must have one or more “To” connections 48, or they are removed from the “From” list by deleting “non-serving routes” (the act of deleting them also updates the destinations (in Step 5). Business rule #4: the connections must be limited to only “one-stop” (where stops=“0”), no route data indicated as “Via” from the carrier's published schedule is needed (the administrative system programmatically makes the “Via” connections). Business rule #5: because multiple carriers 10 may be indicated on the carrier's published schedule, some of these carriers must operate as Affiliates for the benefit of the Parent (called “codeshare” indicated), the “From/To” connections must not contain any “codeshare-indicated”destinations. Business rule #6: as the “From” destinations 46 are connected, the system indicates the number of connections and a “color green” to the right of the “From” location 46, or some other visual indication is made. If the “from” locations have no connections, the system indicates this condition by assigning the number “0” and placing it in a “color red,” or some other visual indication, indicating no connections are made to that “From” location. In this manner, the user can readily check the validity of locations and, if needed, delete those that have no connections by using the “Delete Non-Serving Routes” functionality. Business rule #7: if all the “From” locations 46 are indicated as connected to one or more “To” locations 48, all the “From” locations will be indicated in “green” color and a “complete” status 50 will be indicated to the right of the airline name. Business rule #8: for the “complete” status to be displayed, both destination 14 and connection 16 statuses must be “complete,” otherwise the connections status will be “incomplete.” Business rule #9: it is not important at this step in the process to declare routes as “one-way” or “round-trip,” as the logic in the administrative system incorporates the ability to depart and return wherever connection possibilities occur. The system translates round-trip “From/To” routes and the “To” location acts as a pivot point, regardless of the number of stops, the return route can programmatically make the connections.

After the connections are made, the connections and results table 17 displays the routes and destinations in the following manner:

As shown in FIG. 10—the system 2 will display a carrier's routes 52 on a digital map 54. The user can use the results table links to view routes by selecting one of three links: 1) the entire route network, 2) hub-centric routes or 3) a single route. An exemplary process for retrieving and displaying the travel related information includes the display of the routes as illustrated in FIG. 9.

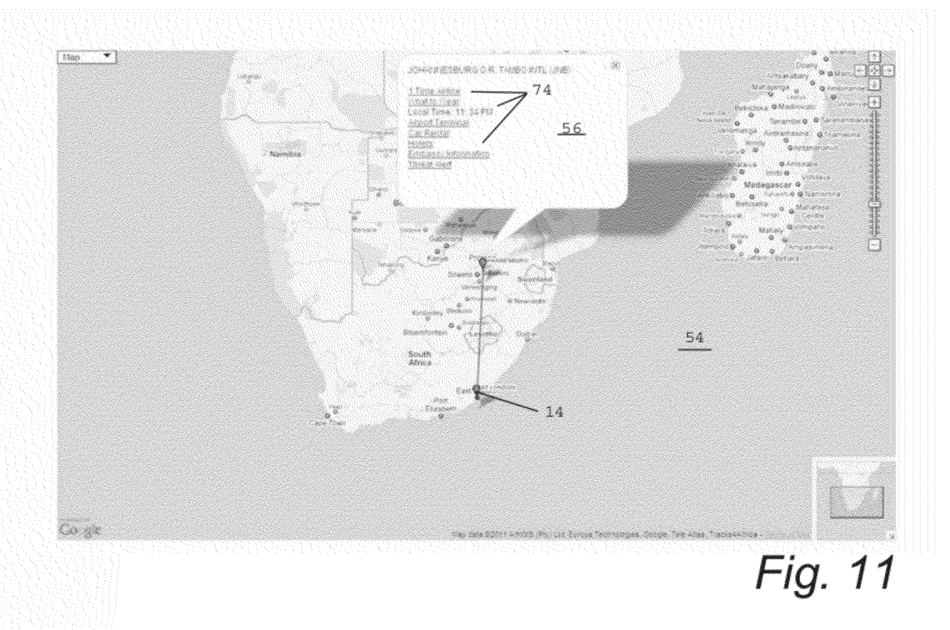

As shown in FIG. 11—the system 2 will display a carrier's ground-based destinations 14 along a route. Destinations along a route are displayed with “markers” on the digital map 54. The user act of selecting a marker will open an “information window” 56 of additional available services 74 specific to the location.

Once the connections are made and validated the user saves the data, may review the associated results table 17 and digital map and moves to the next step.

### VIII. Step 7

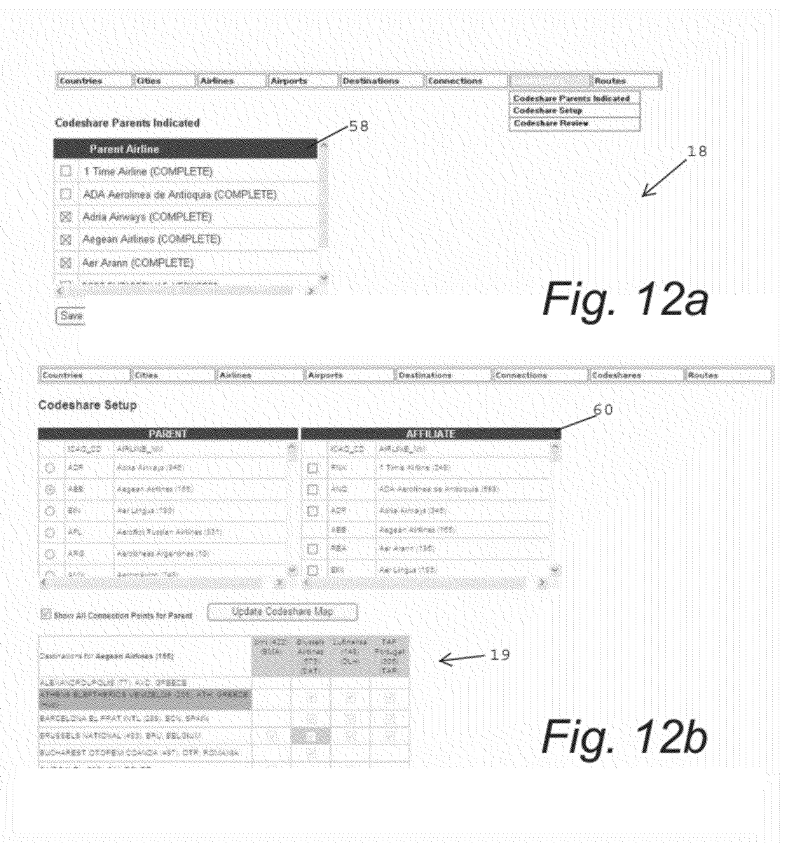

Step 7, as shown in FIG. 1 and in more detail in FIGS. 12A and 12B, indicates codeshare 18 Parent/Affiliate relations created under Step 5, business rule #1. In that step, we specifically excluded “codeshare indicated” carriers because it is easier to relate Parent and Affiliates at the carrier level rather than build them in the routing tables. We also indicated in Step 5, at business rule #2, that some carriers are “codeshare unique,” meaning that they can only operate for other carriers and so will never be considered Parent carriers. Two steps are needed to indicate codeshare relations.

The first step is to indicate which carriers are codeshare Parents—from publically available carrier schedules, the user will indicate which ones are Parents by checking a checkbox associated to the system-generated list of carriers. Business rule #1: the list of codeshare Parents 58 will not include those carriers which are indicated “codeshare unique” as they operate only for other airlines. Codeshare unique carriers (indicated at Step 5) will not appear on the Parent list 58. Business rule #2: there are instances where an Affiliate operates for other carriers and is also a Parent. In this event, the carrier is considered a Parent and should be checked. This is shown in FIG. 12A.

The second step is making codeshare connections using a Codeshare Setup table 60 of publically available carrier schedules, the user will associate codeshare Affiliates to their parent. Business rule #1: Parent carriers are indicated from publicly available schedules having “codeshare” or “alliance” relationships. The user will select a single Parent to which one or more Affiliates will be associated. Business rule #2: A Parent cannot be associated to itself. This is shown in FIG. 12B.

As the codeshare relationships are matched, the results of making the associations are displayed in a codeshare results table 19 indicating codeshare connected possible locations between the Parent and its Affiliate(s). What this means is that routes will be programmatically created joining the Parent and Affiliates at the possible connection points where the two carriers have a common destination presence. If no connection is possible, then there is no common destination associated between the Parent and its Affiliate. Therefore, no codeshare is possible. Business rule #5: The codeshare results table provides a checkbox indicator at the common destinations where codesharing is possible. Business rule #6: Grey colored cells displayed in the results table indicate that the common destination is a hub and, as such, will indicate a high possibility that Parent and Affiliate will connect at this common codeshared location.

### IX. Step 8

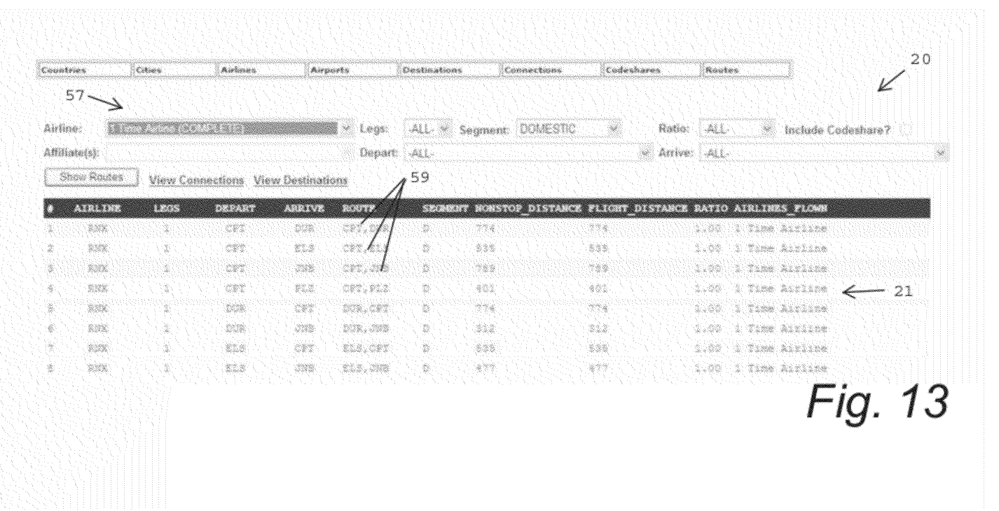

Step 8, as shown in FIG. 1, and in more detail in FIG. 13, requires the user to select variables which in turn result in retrieving, displaying, or changing routing results data 20. Routes 52 generated by the system are displayed in tabular form 57 or on a digital map 54. Using the tabular form, the user will:
select a specific airline or all airlines,
select differing trip types (where non-stop=1 leg, one-stop=2 legs, and so on),
select a segment, domestic, international or both,
select a ratio (a filter),
select whether to include codeshare (by checking the checkbox), where codeshare routes are possible and if so, the user is able to select an individual Affiliate or “All Affiliates”,
select the “From/To” locations.

Based on these selections the route possibilities are displayed in a results table 21.

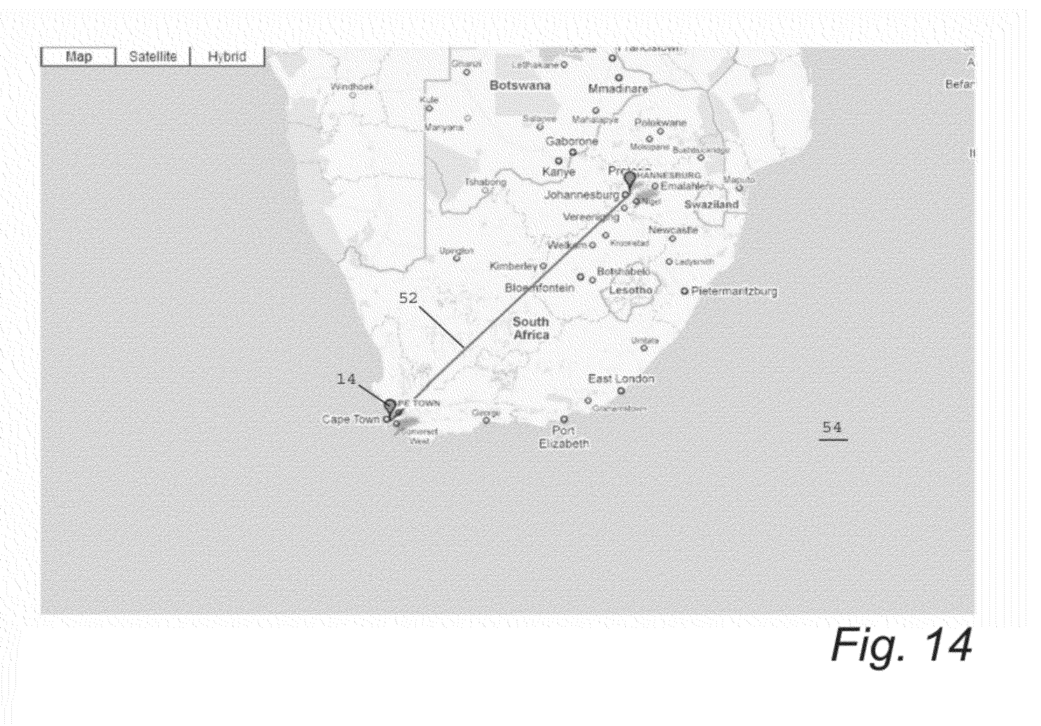

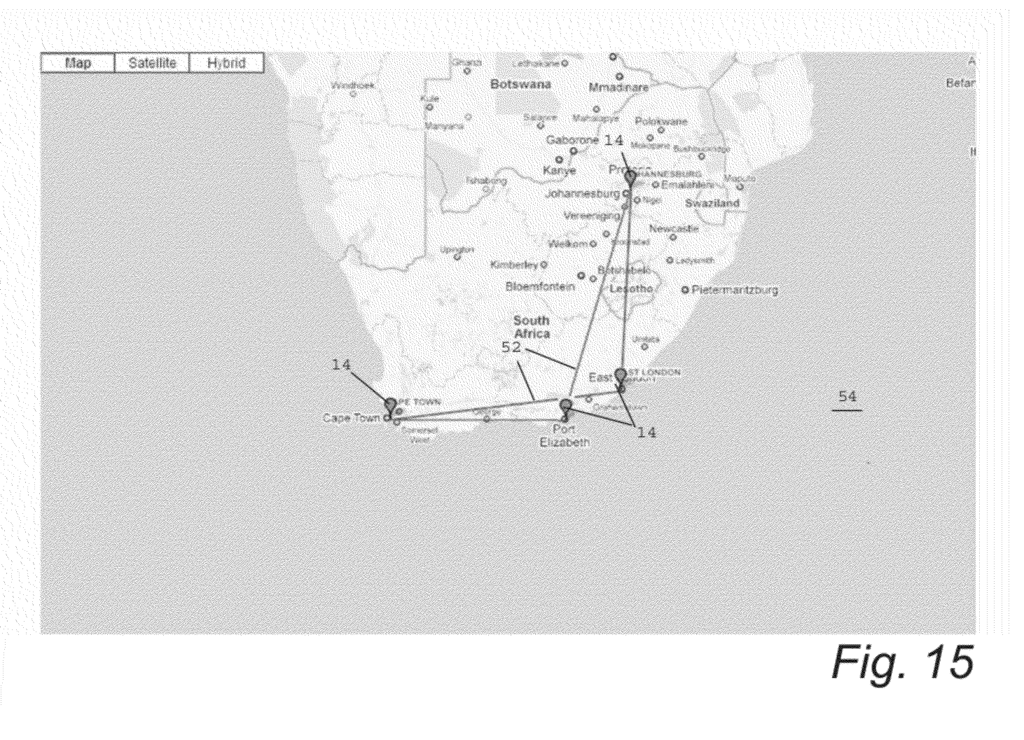

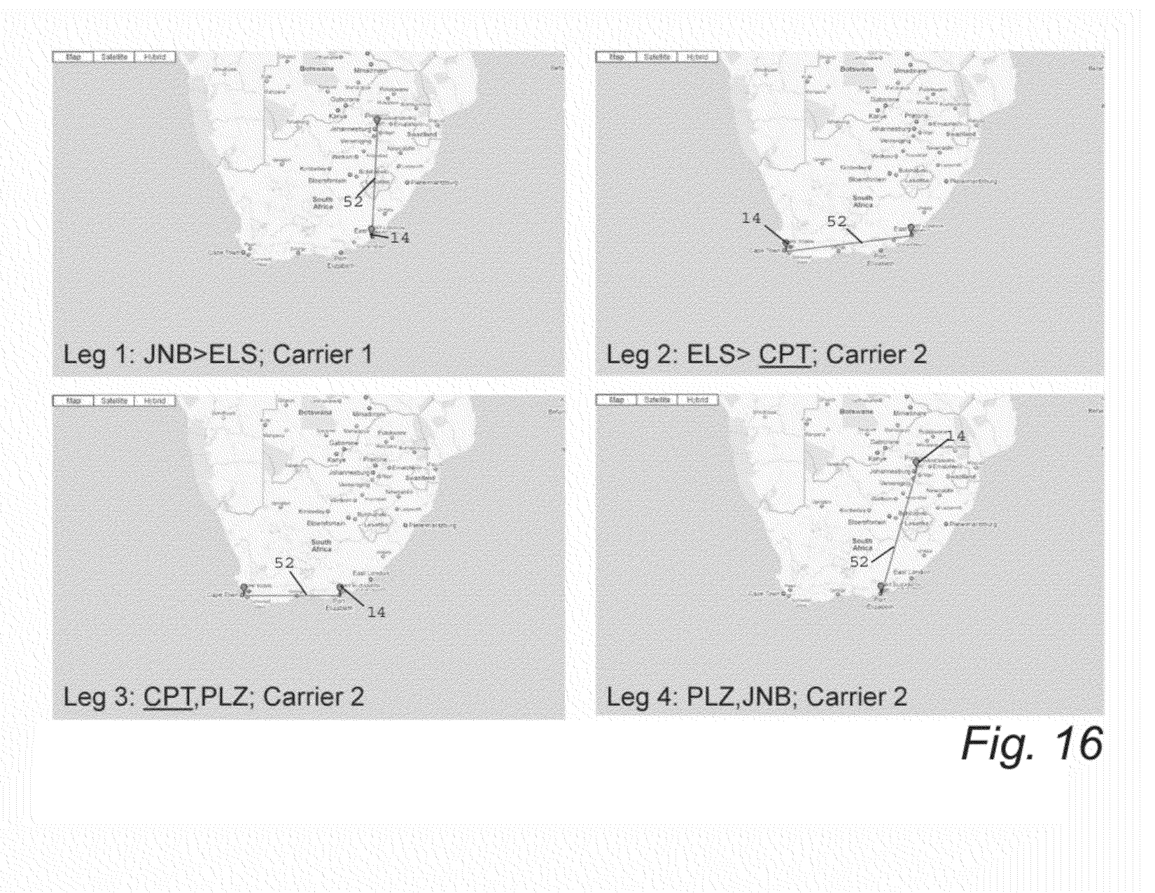

In order to display the route on a digital map, the user selects the route link 59 from the table 21 which opens a window to display the route 52. As an example of route displays generated by the administrative system, a traveler may want to make a round-trip plan from Johannesburg to Cape Town South Africa, as shown in FIG. 14. There are numerous possibilities, but the selected carrier provides only a codeshare route from (outbound) Johannesburg to Cape Town. FIG. 15 displays a route requiring a stop at East London to change carriers, and a return stop through Port Elizabeth. To the administrative system, the trip is actually an assemblage of connections, Johannesburg to East London, East London to Cape Town, Cape Town to Port Elizabeth and Port Elizabeth to Johannesburg, as displayed in more detail in FIG. 16.

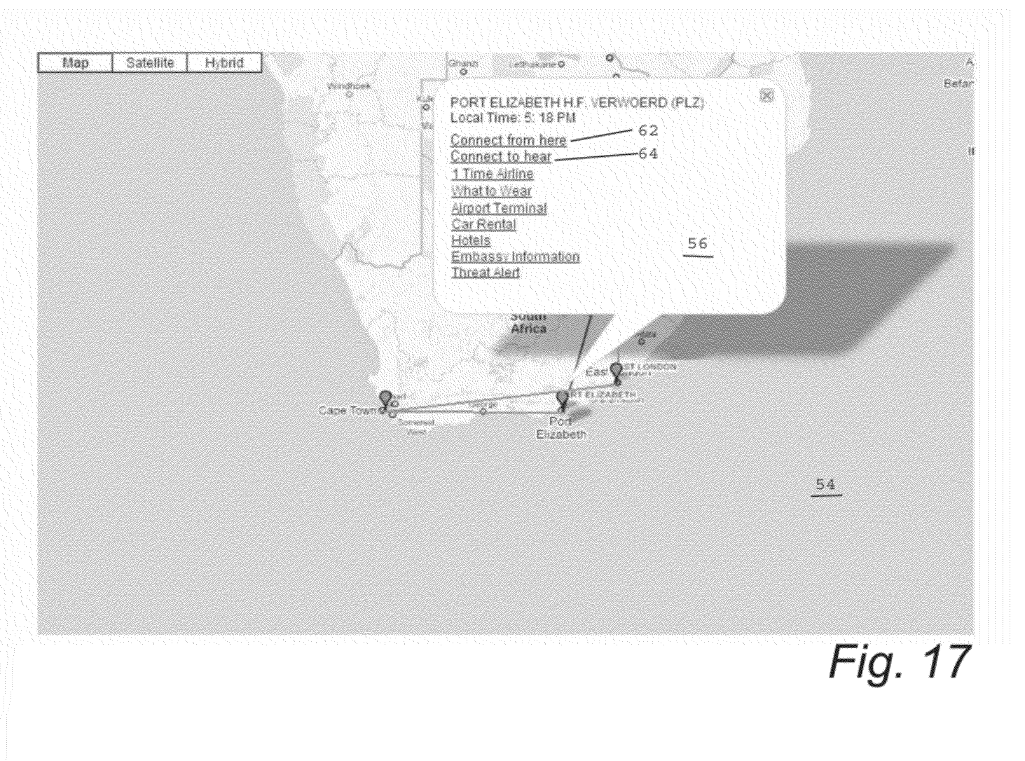

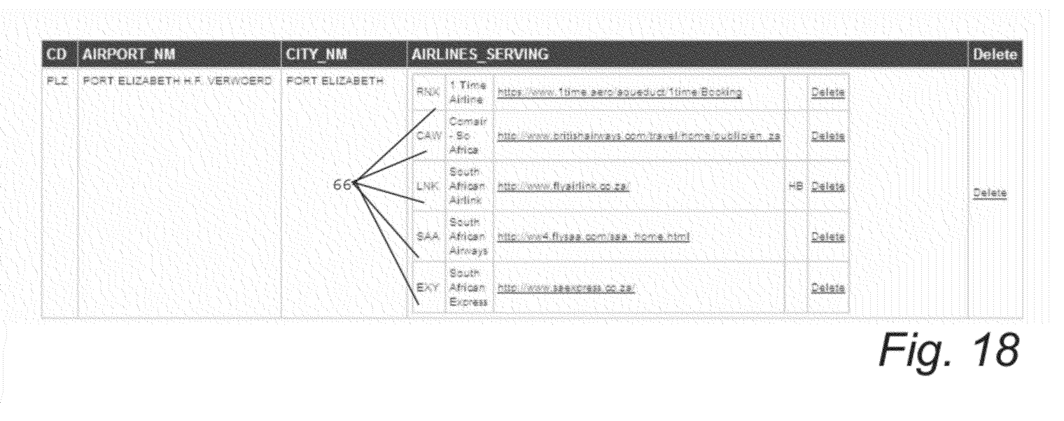

While the map view is displayed, the user may view possible alternative connections. As Shown in FIG. 17, the user must select the location marker (for the example this is at Port Elizabeth) to open an “information window” 56 and select either ‘Connect from here” 62 or “Connect to here” 64 to view all the route possibilities “From/To” the selected location. Whatever carriers are serving the “From/To” location, the system provides the ability to display alternate connections. Using the carrier information located at the connecting destination, the administrative system logic provides the routing alternatives 66, as shown in detail at FIG. 18.

### X. Step 9

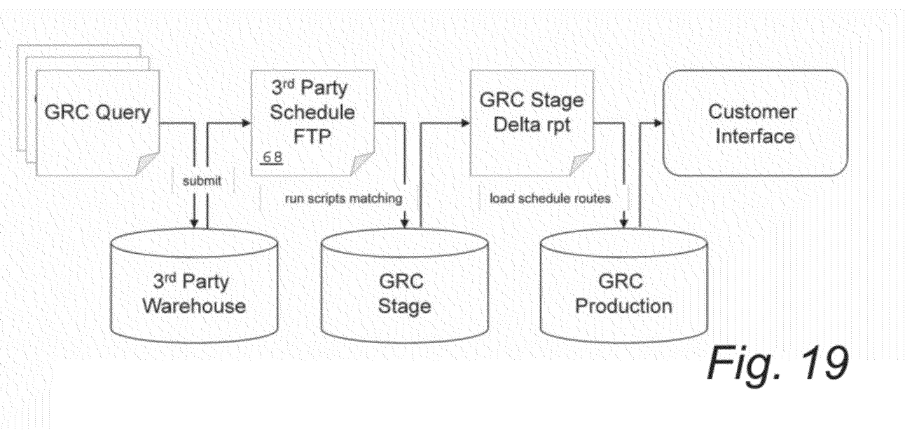

Step 9, as shown in FIG. 1 and in more detail in FIG. 19, requires that once the administrative system has created the route possibilities for all carriers, locations and taken into consideration codeshare and alliances, the administrative system 2 may associate any specific route and trip type (e.g. non-stop, one or two stops) and codeshares/alliances to the carrier provided schedule data. But first, the system will need to match schedule data 22 from the third party system as follows:

Business rule #1: carrier name data must match between the administrative system and the third party data provider. Schedule information is dependent upon matching the airline IATA 28 (2 character identifiers) associations between systems. Business rule #2: in some instances third party IATA codes 28 may have “controlled duplicates” which will have to be manually identified and matched within both the administrative and third party systems.

Next, the system must validate that the administrative system and the third party data have matching facility ICAO codes 26 (3 character identifiers). Business rule #3: in some instances there may not be a direct method of matching ICAO codes 26 because there may not be a master listing of all carriers' facilities and their codes provided from the third party.

Business rule #4: confirm carrier Parent/Affiliate codeshares (or lack thereof) from the third party data.

Business rule #5: the third party data provides the name of a carrier in association to a “from/to” route which can be matched between administrative system 2 and the third party schedule information 68.

Business rule #6: The administrative system provides the appropriate latitude/longitude location data to generate routes 52 on a digital map 54 and associates additional services to locations and carriers for the benefit of the users.

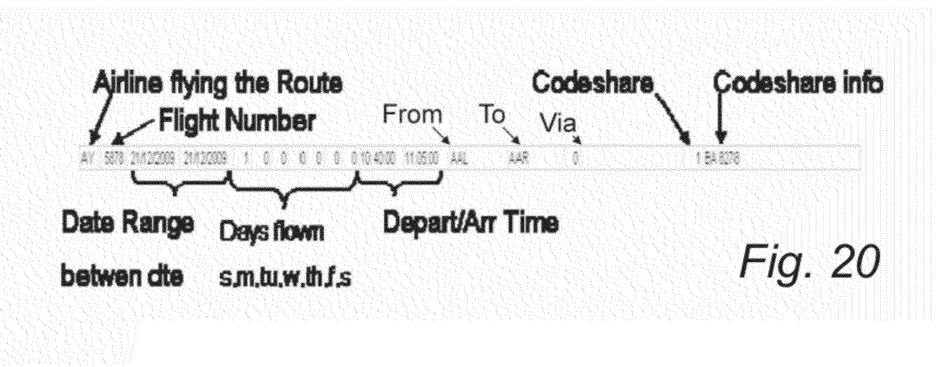

Once the data has gone through this matching process so that all underlying data used by the administrative system is identical to the underlying data provided by the third party, the schedule data 68 provided by the third party can be loaded into administrative system 2 database. Schedule data may be provided through any means: third party, carriers, global distribution systems, data aggregators, affiliate marketers, etc. The actual schedule and fares data (flight number, effective date, travel day, departure/arrival times, etc.) may not need to be stored in the administrative system, as it changes frequently depending on schedule changes. Business rule #7: the frequency of carrier schedule data changes will be updated based on the “effective dates” of the schedule information. Schedule and fare data will be refreshed based on the last date indicated in the effective date, date-range, as shown in FIG. 20.

### XI. Front End System 70 Customer Interface

The front end 70 the customer interface, which provides the “view” to the administrative system 2 information as part of the MVC model, as shown in FIG. 1.

The back-end administrative system 2 (Mapped GIS Distribution System), which generates millions of scheduled routes and associated information, is integrated with the customer interface display of mapped routes and ground-based services, from which the user selects, to create their reservation.

Several special functions included in the customer interface are: a) both key input/mouse and touch functionality incorporated into the customer interface, b) significant new digital map functionality, c) a fully functional digital map capable of being sent to a third party for review and modification, which can subsequently be re-sent back to the originator, d) allowance for the user to select individual carriers (based on preference) or all carriers for comparison shopping, e) allowing the user to select trip type, i.e., non-stop, any number of stops, and/or codeshare separately when comparing routes, schedules and pricing—because selecting trip type allows the user to compare pricing versus trip time, e.g., flying codeshare and multi-stops will be of longer duration, less expensive travel, but a price increase may be acceptable to the user if the travel time is reduced significantly or the increased price is inconsequential to the user.

The customer interface system 70 may determine the device display, size and resolution programmatically, or there may be multiple screen size/resolution class combinations offered to the user wherein he/she may select the appropriate one to become the default display/resolution for the device being used.

Device display size limitations and touch computing force the customer interface to provide “inference computing,” i.e., wherever possible, collecting customer information must be inferred by the system. For example, flight reservation information date/time arrival “To” a location can also be utilized as auto and hotel reservation information—with the system inferring that the flight arrival “To” location will be used as the car and hotel location and car and hotel reservations occurring as either before or after the flight arrival date/time. Inference computing supports reduced data presentation, reduced duplication of effort, reduced data storage and therefore less cost.

Travel plans change—postponed/cancelled meetings, flights, conflicts, delays, etc. Change forces a rush to communicate and needless worry. It is fairly simple to provide information about which airlines serve what airports, but that information doesn't solve the problem of which airlines fly what routes to or from that particular airport. The user wants to determine which routes will avoid the change, and which flights fit the user's schedule. The customer interface provides: 1) which airlines fly the routes to and from a particular airport and 2) what flight choices are available on the day needing to be changed. Prior to the change request being made, the user will have the needed information.

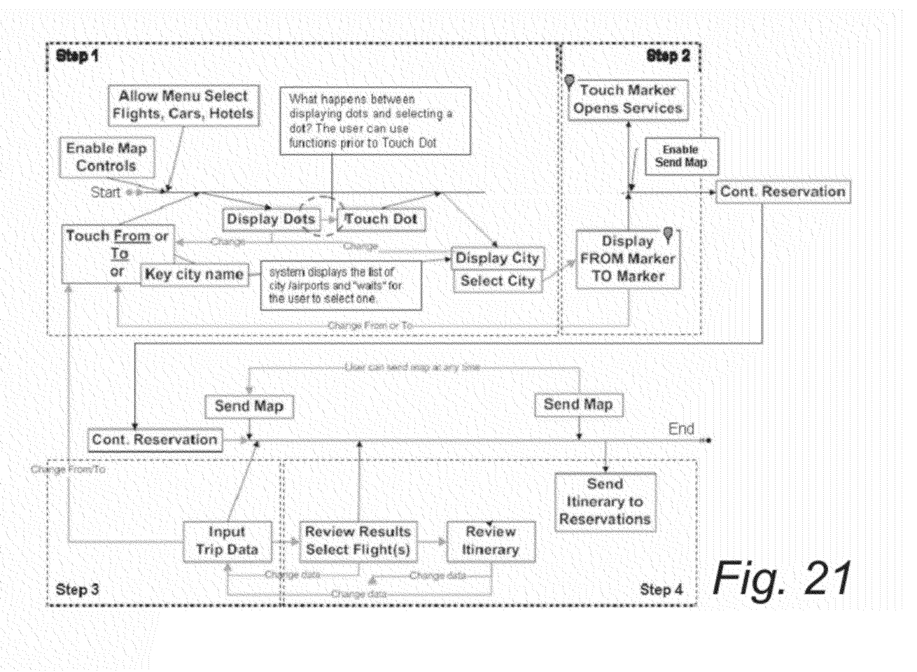

As shown primarily in FIG. 21, the customer interface process, steps 1-4 provide the ability to: select, change and display “From/To” locations and offer information specific to the location, programmatically provide marker locations and display a route-track line between the markers, create a flight, car or hotel reservation and display locations, routings and services while using the map and create/change/send the map and itinerary to others, external to the application.

Contained within each step of the process is key business logic translated into functional design specifications which allow for real-world considerations supporting the generation of a mapped itinerary taking into consideration: a) markers are provided on the digital map for each “From” and “To” location and additional markers may represent point-to-multipoint “stops,” b) the user may interact with markers and route-track lines connecting the markers with system information provided specific to the location or route and c) the user may make choices among alternatives with the system displaying different routes in support of changing their requests.

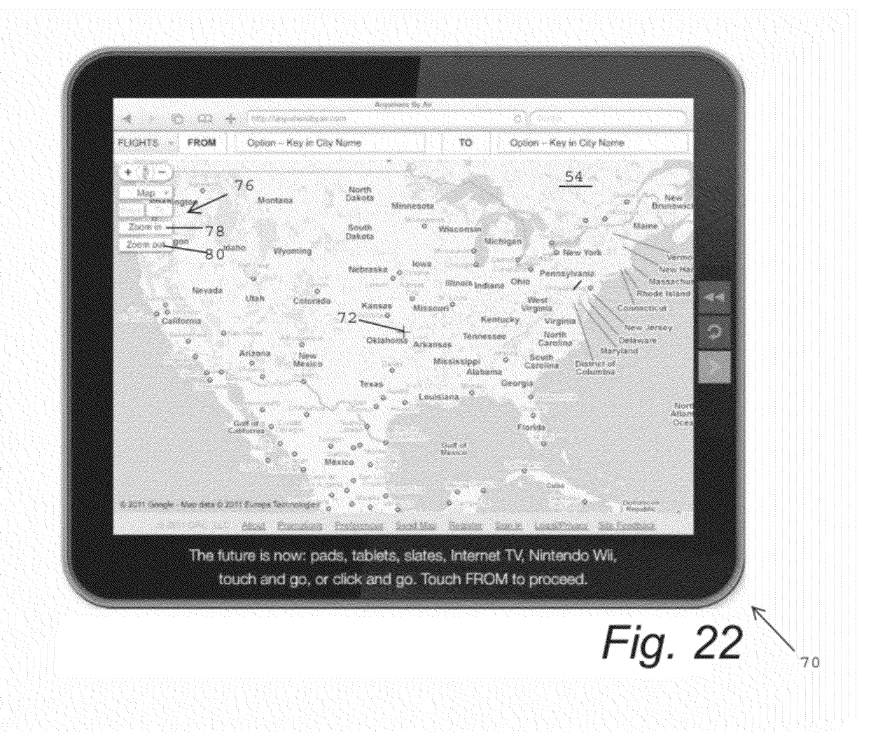

In an exemplary embodiment, at opening of the customer interface, the default menu is set to “flights.” The map is set to a preset zoom level. The top menu window is fixed atop the map. A crosshair 72 is visible in the center of the map display 54. Standard zoom controls 76 and other map functions are enabled, e.g., map move, double tap to zoom (where “touch computing” is utilized), etc. Custom map controls, “From” and “To” are disabled. Custom map controls, “Zoom-in” 78 and “Zoom-out” 80 are enabled, as shown in FIG. 22. Business rule #1: References to “touch,” “click,” and “voice” are used interchangeably. The user may either touch or click a control (a button, menu or other interface function) which produces a result, or the user may use programmed voice commands to achieve the same result, depending on the interfacing capabilities of the user's device. Business rule #2: the user must be able to select the map or controls at any time during their session, thereby interrupting the process.

Custom map controls, also shown in FIGS. 21 and 22, help the user quickly find mapped locations along routes. Map, satellite, hybrid, street and zoom controls are standard functionality included with digital map systems (exemplified herein as a drop down pick-list). Customized map controls are provided (but are not limited to) those described below, and shown in detail in FIGS. 21, 22, and 31:
a) “Crosshair” 72—displays at the center of the map. The user may move the map “under the crosshair” for greater precision while using “Zoom-in” and “Zoom-out” custom controls or standard map functionality.
b) “From” control 76—selecting a “From” location creates and displays an “F” marker 98 on the map (step #2 below). Should the user move the map marker out of the displayed view, selecting the “From” control programmatically centers the “F” marker on the map display at a preset zoom level under the map crosshair. Business rule #1: the “From” control is disabled until the “F” marker is displayed on the map.
c) “To” control 76—selecting a “To” location creates and displays a “T” marker on the map (step #2 below). Should the user move the map marker out of the displayed view, selecting the “To” control programmatically centers the “T” marker 99 on the map display at a preset zoom level under the map crosshair. Business rule #1: the “To” control is disabled until the “T” marker is displayed on the map.
d) Using either the “Zoom-in” 78 or “Zoom-out” 80 control programmatically zooms the map display at a preset zoom level. “Zoom-out” facilitates viewing of the entire route “zoom to fit all markers.” “Zoom-in” facilitates viewing “up close” and programmatically uses satellite/hybrid view. Used in conjunction with the “From” and “To” controls, “Zoom-in” and “Zoom-out” help the user find marked locations.

e) Where point-to-multipoint routes are displayed (routes having “Stops”) a “V” label displays on the “Stop” markers 100. Since there may be multiple “Stops,” the user may position the map crosshair on the “V” label marker and select “Zoom-in” or “Zoom-out” to view map details.

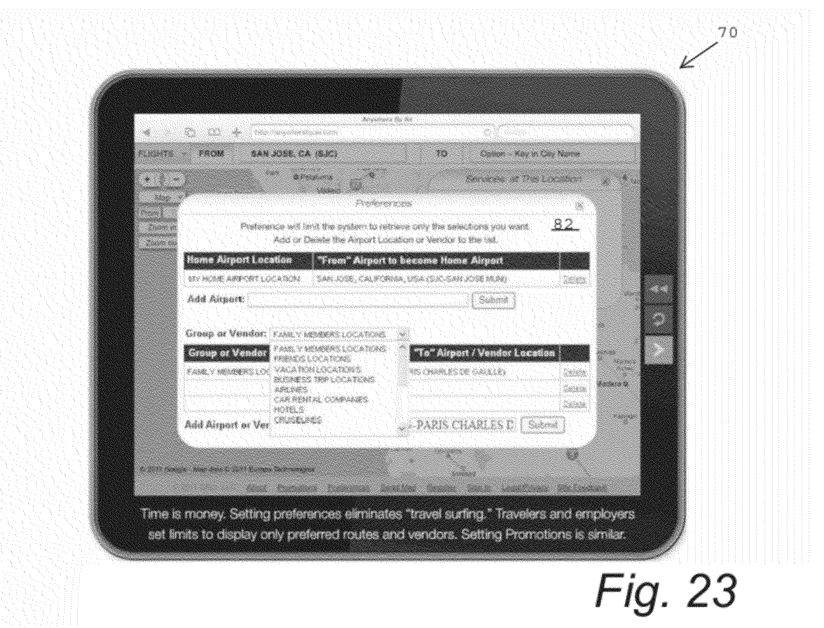

The front end system 70 will indicate user preferences as shown in FIG. 23, based on user preference selections 82. Only those items chosen (e.g. routes or vendors) will be available to the user to select from in the customer interface. Creating one or more preferences has the effect of reducing retrieval to only what the user wants retrieved. For example, as shown in FIG. 23, if the user wants to fly only between only two selected locations, setting a preference 82 will limit the data retrieval to only those two locations. No other data will be made available in the customer interface for the user to select. This functionality also works well for limiting travel choices based on preferred vendor arrangements and routes.

Examples of user preference choices include, but are not limited to:
“From” airport as a “Home” airport, which will cause the “From” menu item to retrieve the user's indicated home city/airport
Preference by Family members' locations as indicated previously by the user
Preference by Friends' locations as indicated previously by the user
Preference by Vacation locations as indicated previously by the user or stored by the system from previous trips
Preference by Business locations as indicated previously by the user
Preference by Carriers/Vendors

In order to save their preferences, users are required to create an account and sign-in. This causes the front end system 70 to communicate directly with the back-end system 2 and information is shared between the back-end network server (including numerous computing systems with processors and suitable memory storage) and the user's mobile device which stores the front-end system 70. The user can “turn on” and “turn off” preferences once the user has signed-in.

The customer interface displays route-driven maps so the user can easily see the promoted routes. Promoted routes may be specially indicated by the back end system 2 as having special fares for a particular day or travel destination, or based upon some other arrangement between the provider and the airline or service. Additional features allow the user to view other promotion types (e.g. miles, rewards, alliance, coupon) if desired.

When the Promotion menu item is selected, the user can find promotional routes by selecting one of the following from a drop-down pick list:
1. By Airline—if the user selects “By Airline” all the promotional route results available will be displayed for the selected airline. From the results returned, the user can make a selection and the route will be displayed on the map.
2. By Interconnecting Flights—“Interconnecting” is defined as one or more airlines whose promotional routes are connected by a common location. For instance, if “Airline A” has a promotion from City-Airport “A” to City-Airport “B” and “Airline B” has a promotion from City-Airport “B” to City-Airport “C,” then the contiguous route from City-Airport “A” to “C” would be shown in the results. From the results returned the user can select a promoted interconnected route for display on the map. Business rule #1: no more than 2 Stops are allowed
3. By Country—if the user selects “Display Country” all the promotional routes available will be displayed for all airlines having originating or terminating flights within the country selected. From the results returned the user can select a promoted route for display on the map.
4. By State/Province (USA and Canada only)—if the user selects “Display State/Province” all the promotional routes available will be displayed for all airlines having originating or terminating flights within the State/Province selected. From the results returned the user can select a promoted route for display on the map.
5. By City—if the user selects “Display City” all the promotional routes available will be displayed for all airlines having originating or terminating flights within the City selected. From the results returned the user can select a promoted route for display on the map.

### XII. Step 1

Step 1 on the customer front-end 70 is to select “to” and “from” locations. The “From” and “To” links (shown as bold font on the customer interface menuwindow) are touch-capable (on an appropriate device such as a tablet or touch-screen phone) menu links that begin the process of making a reservation. Alternately, the user can key entry or voice command to begin the reservation process. The “Touch” and “Key Entry” processes are further described below.

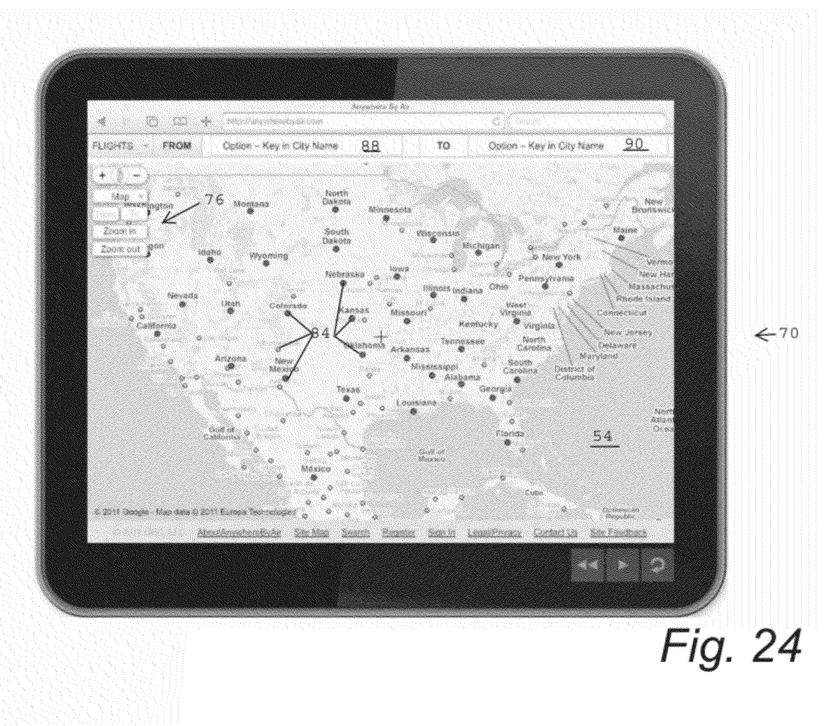

FIG. 24: Touch Process—“From” and “To” touch controls work independently from each other and independent of all other menu selections and map controls. Once a “From” or “To” menu item is touched, touch capable colored “dots” 84 display on the map 54 associated to a country, state (USA) or province (Canada). The “dots” function is further explained (below).

The user interface shown in FIG. 24 allows for the user to explore the map and the world using the user interface and the information and data stored on the back-end administrative system 2. This “exploration process” can be used to plan trips where the user is not certain where they want to or need to go. It can also be used as an educational tool for children to explore geography. The uses of this interface are limitless. The user simply moves the map around and can select the “dots” 84 to find more information on a particular state or country. The user can learn about flight paths, and other information may be available at all listed destinations via the information window 56 accessible by the user, including city, state, or country web portals and wiki pages.

If the user selects either the “From” or “To” link—the system displays dots 84 on the map associated to each country, state (USA) and province (Canada). The map displays at a system-preset zoom level. If the country/state or province is not within the displayed view, the user may move the map 54 (“drag” the map) in order to view and to select a dot. Business rule #1: Once the user touches the map display, the “From” menu window loses focus but if the user re-touches the “From” menu window, it regains focus.

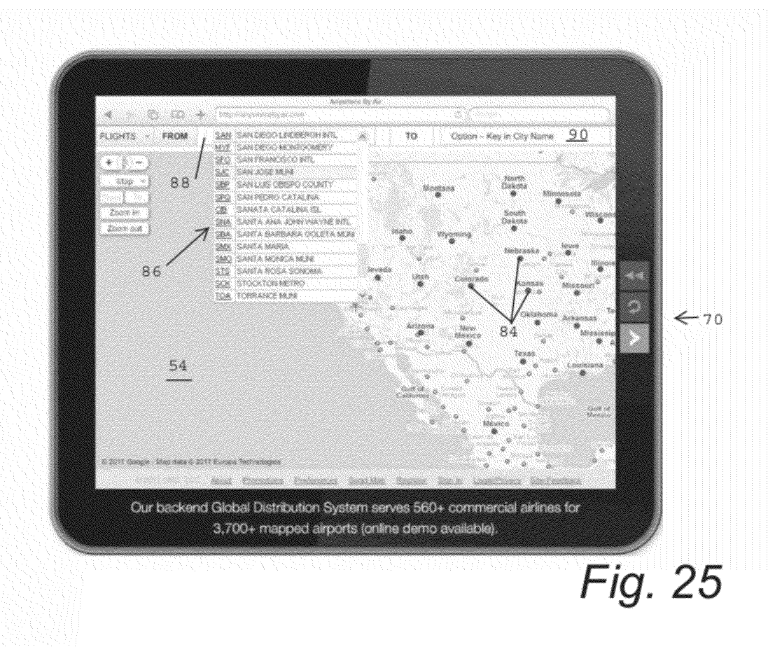

As shown in FIG. 25, after touching a dot 84, the system programmatically provides a list of associated cities and airports from which the user selects. Business rule #2: the airport list is populated only with cities or airports which have scheduled flight connections. The list may not include all cities or airports provided in the administrative data. Business rule #3: if more than one airport is associated to a city, the list may have “nested” airport listings wherein a “+” is displayed to the left of the city name, which when touched would reveal the associated airports.

The user selects a city name or airport from the list 86 or the user interrupts the process to re-select a dot from the map before the city name/airport is selected. Business rule #4: if the user selects a different dot, thereby causing the “From” or “To” menu window to lose focus, the appropriate drop-down list box is cleared, and the process restarts. Business rule #5: after the “Display of Dots” and before “Picking a Dot,” the user can use any of the functions evidenced prior to touching a dot, i.e., change menu selection, or reselect “From” 88 or “To” 90 links. Business rule #6: selecting the “From” link 88 programmatically produces dots; however, if the user interrupts the process and touches the “To” link—following touching the “From” 88 link—the dots will refresh and re-display, and processing for the “To” location will begin. Business rule #7: selecting one of the dots programmatically displays a list of city names and airports associated with that dot. If the user changes from selecting the “From” link, interrupting the process to select the “To” 90 link, the system will refresh and re-display (clear the “From” list 86) and begin the “To” process. Business rule #8: if the user selects a different dot causing the “From” or “To” menu window to lose focus, the appropriate drop-down list box is cleared and the process restarts.

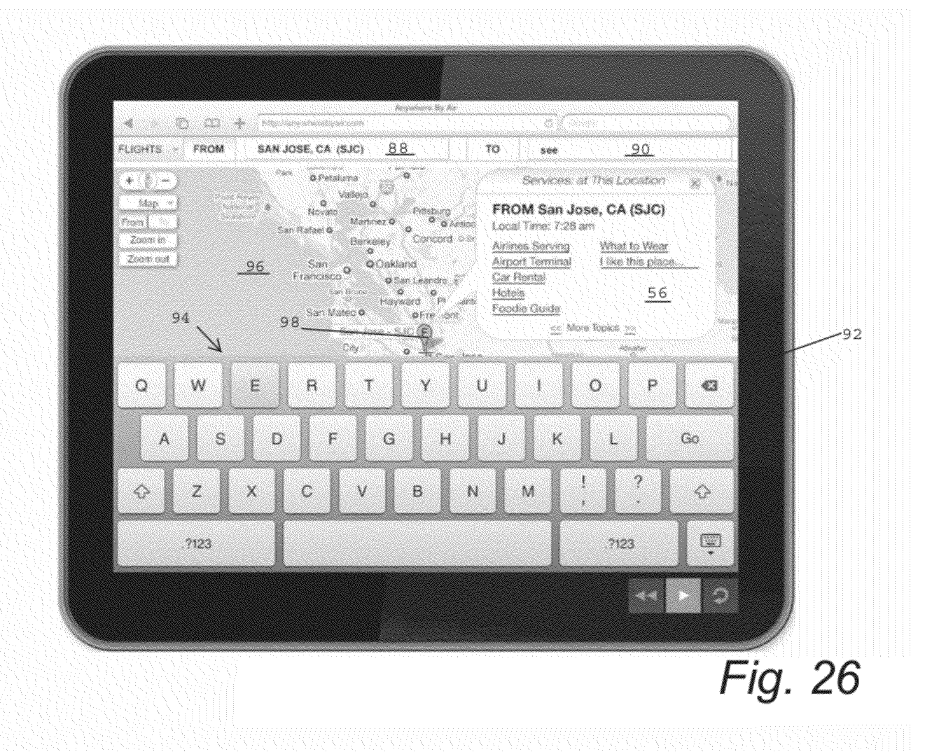

As shown in FIG. 26, the user's mobile device may include the ability to physically key in words or numbers. Many devices include an electronic keyboard 94 on the touch-screen portion 96 of the mobile device 92. The user may choose to key-input the city name in either the “From” 88 or “To” 90 drop-down edit box or speak the city name once the edit box is selected if their device includes the capability to recognize speech commands. As soon as the user selects the edit box, an electronic keyboard will appear allowing the user to key in the name of the city or the user can speak the name of the location.

Retrieval of the city or airport name will not begin until the user keys the first three letters of the city name or airport code which begins the administrative system 2 retrieval process of city name, after which a drop-down list box displays the available city name/airport listings. Business rule #9: the retrieval is based either on keying in the first three letters of the city name or the airport code or speaking the city name.

The user selects a city name/airport from the list 86 or the user can interrupt the process to re-select a dot 84 from the map before the city name/airport is selected. Business rule #10: if the user doesn't touch the “From” link 88 but selects the “From” edit box, the user may key in the first three letters of the city name to retrieve the city name/airports list. Business rule #11: if the user touches the “From” link 88 (which displays the dots), but doesn't touch a dot, the user may instead key in a city name in the edit box because a dot has not been touched. Business rule #12: the user may reselect the edit box and speak the city name to retrieve a different city.

After selecting a city/airport from the list, the system programmatically creates a marker 98 at the location on the map and continues to Step #2.

### XIII. Step 2

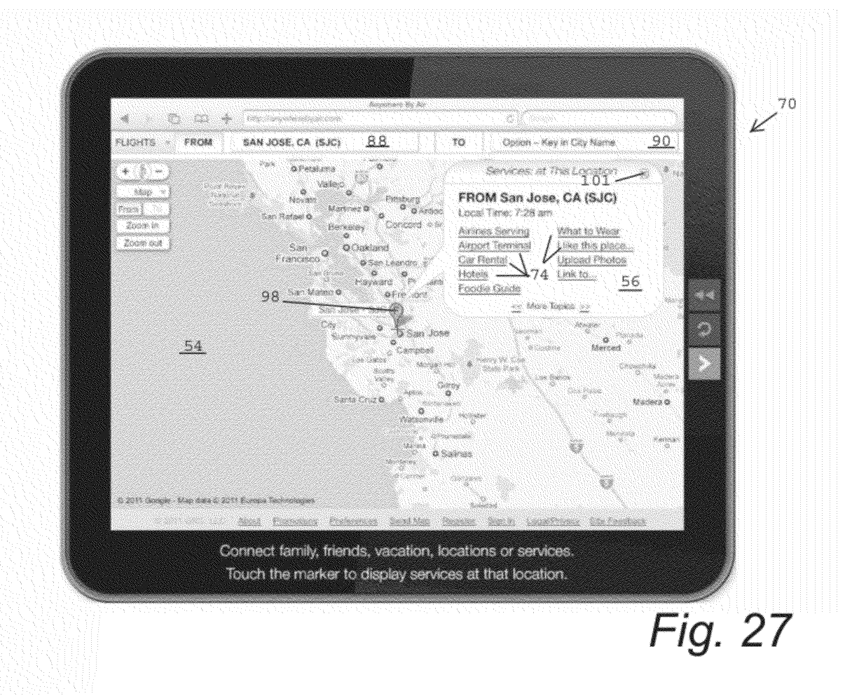

As shown in FIG. 27, Step 2 requires the system to generate map markers 98 onto the digital map 54 after a “From” or “To” city name/airport is selected (step #1). A marker is programmatically produced on the map 54 and is associated to the selected city name/airport selected. Business rule #1: There can only be a single “From” and “To” location marker displayed on the map. Business rule #2: the user is able to change the “From” location after the marker is displayed on the map. Any associated route track lines, e.g., connecting the “To” markers, will be removed from the map display.

The marker displays 98 on the map at a latitude/longitude from data provided by the administrative system 2. The marker displays an “F” or “T” as its label, (meaning it is either the “From” or “To” location) along with a label of the city name and airport code. Business rule #3: as the user zooms closer to a “Street View” on the map, the digital map 54 may lose the map reference to the city name, so the name label will reference the location in any language based on user needs.

Simultaneously, as the “F” or “T” marker system positioned on the map, the “From” or “To” menu window looses focus and the “From” or “To” marker window 56 opens automatically pointing to its associated marker. The digital map's custom controls, “From” or “To” are enabled based on their respective marker being displayed.

Business rule #4: if the user decides to touch the map for any reason, the “From” or “To” marker window “hides” and the user must touch or click the “F” or “T” marker to re-display the marker window.

Once both the “From” 98 and “To” 99 markers are displayed, a line joins the two markers. Business rule #5: if the user decides to change either “From” or “To” locations, the select “From/To” locations (Step #1) process restarts, the line is destroyed and the remaining marker is retained on the map display. Once the user has selected a new location and a marker is displayed, the route line 52 re-connects the markers. Business rule #6: Changing the “From” airport marker removes all other displayed markers and route track lines but leaves the “To” marker displayed at its location.

Selecting a trip, “Flights” for example, and having both “From” and “To” markers displayed, provides the “Continue Reservation” tab. Selecting the “Continue Reservation” tab moves the process to Step #3.

Alternately, the user can select a “From” or “To” marker anytime the marker is displayed on the map and additional functionality is provided through the “Services at this Location” marker window 56 specific to the location.

As shown in FIG. 27, selecting a displayed marker 98, 99 on the digital map 54 provides access to a “Services: at this Location” marker window 56. The user may select any of the services 74 displayed on the marker window 56, continue making a reservation, change the “From/To” location markers 98, 99; or select the “From” or “To” map controls to re-position and retrieve either marker. Business rule #6: if the user touches or clicks the map, the “Services: at this Location” markerwindow closes. Business rule #7: the user may close the “Services: at the Location” markerwindow by selecting the close (“x”) 101 and re-open it by repeating the steps above.

Some unique system presentations specifically related to the location visited (but not limited to these selections) are:
Airlines serving this route—travel plans change—postponed/cancelled meetings, flights, conflicts, delays, etc. Changes force a rush to communicate and needless worry. It's fairly simple to provide information about which airlines serve what airports, but that information doesn't solve the problem of which airlines fly what routes in-to/out-of the airport. Which routes “get me around the change”? The customer interface map provides which airlines fly in-to/out-of the airport and the routes they follow.
In order to display the airlines' routes serving the airport the user must 1) select an airline from the list, and 2) the administrative system will provide the connected routes based on non-stop, one or two stop; and codeshare for each airline. Business rule #8: the system will not provide “codeshare unique” or “codeshare indicated” carriers. Business rule #9: the presentation of routes is not based on any particular schedule (because it is unknown), only that the airline, or one of its partners, “fly the route.”
What to wear—current and forecast local weather at this location;
Car rental agencies listing—at this location (not availabilities) including customer service phone numbers;
Hotels listing—at this location (not availabilities) including customer service phone numbers;
Foodie Guide—restaurants at this location, including customer service phone numbers;
Airport terminal information—at this location (official guide)
Local time—at this location;
“I like this place”—allows user comments, attachments or photos to be associated to this location.

Once the map displays either a “From” 98 or “To” 99 marker on the map, the user can send the map, along with markers, routes, services and contents—to other persons via the internet or some other connection capable of sharing data. “Send Map” copies the address of the customer interface website, where the user is working with the map, as an external link into a new map window. The user receiving the link can open it to review the sender's map and information, make changes to it, resend the map or “Save as a favorite or bookmark” on their local computer or mobile device. This feature:
Copies the current website address as a link (whatever is displayed on the map and all of its contents).
Allows an identifier to be appended onto the end of the link name.
Allows the current website map “Save as a favorite or bookmark” to be stored on the user's computer.
Allows the user to add multiple email addresses (manual or automated) to which the user will send the map.
Allows up to a 200 character “Comments” section.

### XIV. Step 3

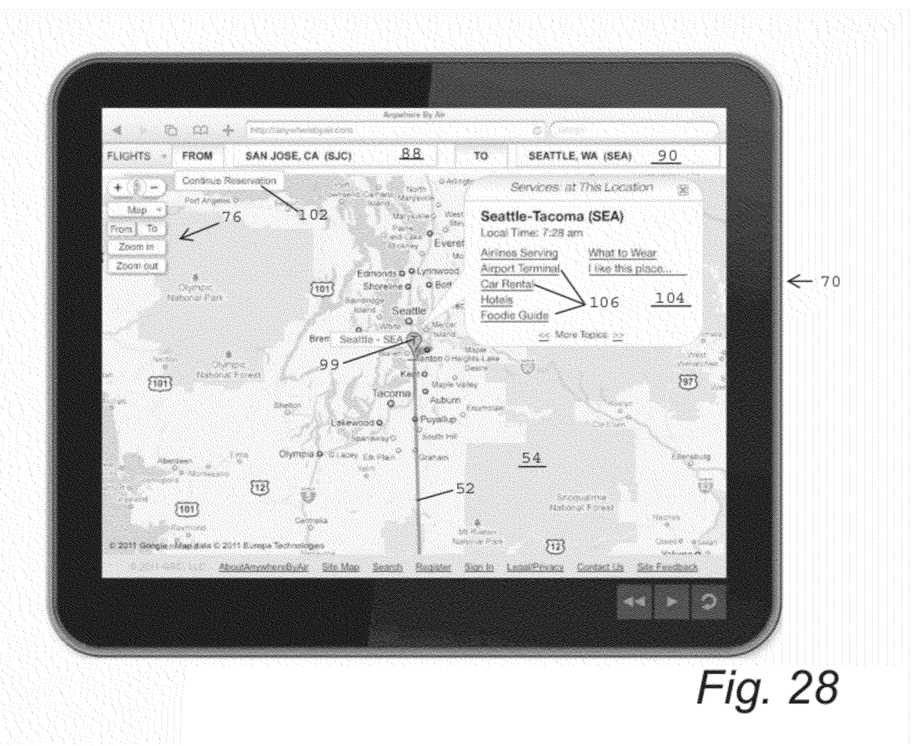

As shown in FIG. 28, Step 3 allows a user to continue the reservation process begun in Step 2. The user must input trip data in order to continue the reservation process. One of the choices 016 “Flights,” “Cars,” “Hotels,” “Cruise,” or other options must be selected, and both the “From” 98 and “To” 99 location markers must be displayed on the map. Business rule #1: by default, at opening of the customer interface, the “Flights” menu choice is selected.

Selecting the “Continue Reservation” tab 102 opens the reservation menu window 104. The user is presented with choices 106 which, once completed, allow the user to advance to the next step in the process.

Referring to our example, if the “Flights” menu choice is selected and both “From” 98 and “To” 99 markers have been selected and displayed on the map 54 (steps 1 and 2 above), the “Continue Reservation” tab 102 will display. business rule #2: if the user selects the “From” and “To” locations, (both markers are displayed on the map), but not the “Flights” or any of the other services, the “Continue Reservations” tab 102 will not display. Business rule #3: if the user selects the “Flights” or any of the other services, but has not completed the “From” or “To” locations (either of the markers is not displayed), the “Continue Reservations” tab 102 will not display. Business rule #4: if the user changes either the “From” 98 or “To” 99 location markers, the “Continue Reservation” tab 102 will be hidden from the display until newly selected “From” and “To” markers are displayed.

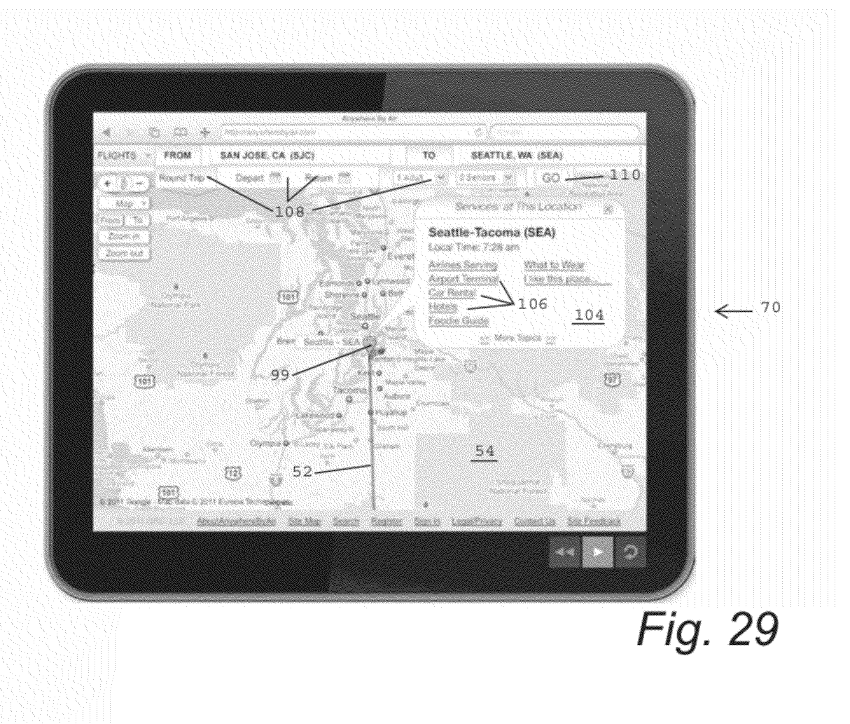

As shown in FIG. 29, selecting “Continue Reservation” tab 102 displays the following flight inputs 108 for the user to complete:
One-way/Round-trip indicated—the system default selection is “Round-trip” and the user may select “One-way.” Business rule #5; if the user selects “One-way,” the system presents only the ability to indicate departure date/time—the return date/time are hidden from view. Business rule #6: if the user selects “Round-trip,” the system presents both depart date/time and return date/time.
Depart Date/Time—the default value is null.
Return Date/Time—the default value is null.
Number and Type of persons travelling—the default is “1 Adult,” “0 Seniors.”

Optionally, the user can choose to view which airlines are serving the “From/To” route 52. This functionality is basically the route with a view of airlines serving the route and the ability to select the trip type: non-stop, one or two stops or codeshare. This view does not take into consideration the schedule of any airline, but rather only the airlines which can fly the route. Business rule #7: changing any of the input values, including “From” and “To” at this point in the process will not result in changing the results output. The results output of flights and fares are created only after the “Go” button is selected. The user completes the information and selects “Go” 110 to continue to step #4, “View Plan/Book Reservation.”

### XV. Step 4

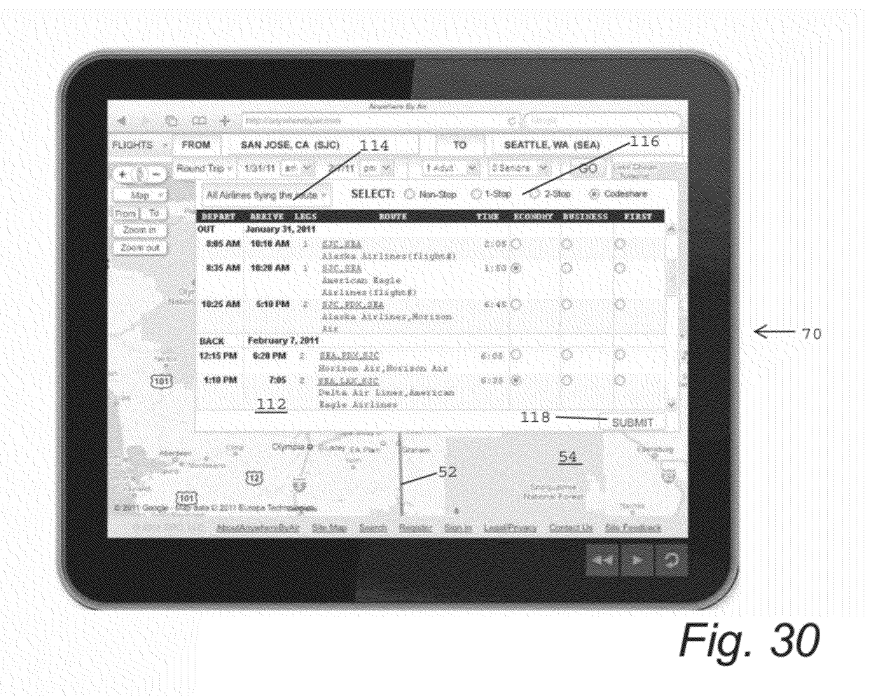

As shown in FIG. 30, Step 4 retrieves and displays the routes 52 and travel plan. Once the user indicates his or her reservation choices and selects the “Go” control, a data window 112 opens for the user to view the results. Business rule #1: the system 70 defaults to return “All airlines flying the route” and a trip type of “Codeshare.” The user may select a different airline from the drop-down list box 114 and a different trip type 116 such as “non-stop,” “one-stop” or “two-stop.” The result of selections will produce a list of one or more carriers meeting the inputs.

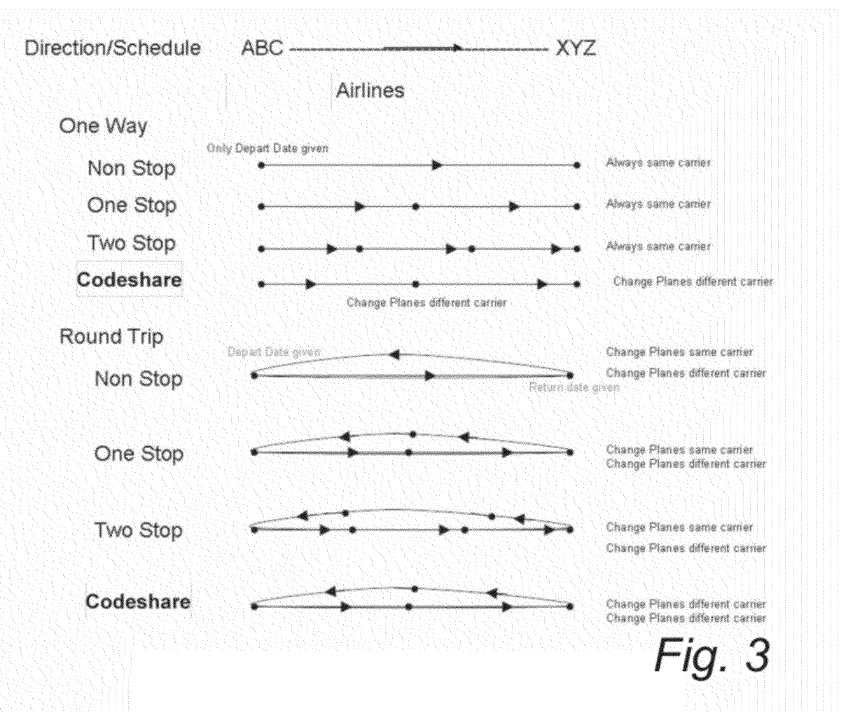

The system 70 will display the routes 52 based on one-way (“out”) or round trip (“out” and “back”) locations and carrier schedule. Some exemplary routing illustrations for each scenario 1-9 are listed below and in more detail in FIG. 3. The various possibilities of route displays include:
1. One-way, depart date only (no return date), non-stop—direct, no carrier or plane change, the route-track line will be a single line connecting two markers, the departure “From” and arrival “To” markers.
2. One-way, depart date only (no return date), one-stop—stop with no carrier or plane change, the route-track line will be interrupted by a single “Stop” marker between the departure “From” and arrival “To” markers.
3. One-way, depart date only (no return date), two-stops, stops with no carrier or plane change, the route track line will be interrupted by two “stop” markers between the departure “From” and arrival “To” markers.
4. One-way, depart date only (no return date), (codeshare)—one stop with definite carrier and/or plane change subject to the coordination of the two carriers' schedules, the route-track line will be interrupted by a single “Stop” marker between the departure “From” and arrival “To” markers. The carrier/plane change will occur at the stop. A Parent carrier/plane will serve the route “From” marker to the stop, and an Affiliate carrier/plane will serve from the stop to the “To” marker.
5. Round-trip, depart and return date, non-stop—direct, no carrier/plane change but assumes traveler will leave at the departure “From” marker and return to the point of origin at a later date/time. The route-track line will be a single line between two markers for both departure “From” and return trip, date of return being the only differentiator.
6. Round-trip, depart and return date, one-stop—stop with no carrier/plane change but assumes traveler will leave at the departure “From” marker and return to the point of origin at a later date/time. The route-track line will be interrupted by a single marker between the departure “From” and arrival “To” markers. The out-bound route-track line may be different from the return route-track line if the stop is not the same for outbound and return.
7. Round trip, depart and return date, two-stop—stops with no carrier/plane change but assumes traveler will leave at the departure “From” and return to the point of origin from the “To” marker at a later date/time. The route-track line will be interrupted by two markers between the departure “From” and arrival “To” markers. The out-bound route-track line may be different from the return route-track line if the stops are not the same for outbound and return.
8. Round trip, depart and return date, codeshare—one stop with definite carrier and/or plane change subject to the coordination of the two carriers' schedules, the route-track line will be interrupted by a single marker between the departure “From” and arrival “To” markers. The carrier/plane change will occur at the stop. A carrier/plane will serve the route “From” marker to the stop, and a different carrier/plane will serve from the stop to the “To” marker. The return to the origination “From” may be accomplished by the same or differing carriers and by the same or differing route.
9. “Milkrun,” is a series of system-determined or custom-user defined stops which indicate a carrier's routes occurring without a hub/spoke method of route networking The “Milkrun” route will require frequent stops based on the carrier routing/schedule, which cannot be altered to accommodate the user.

Based on an example where “round-trip” has been selected, the user further selects the appropriate round-trip “departure” and “return” routes associated with the flight information, and the fare for which the results list produces the appropriate route on the map. See FIG. 30. The results are identified as one or more carriers traveling the route 52 based on the type of travel selected. Business rule #2: selecting any one of the three fares, “Economy”, “Business” or “First” has the effect of programmatically producing the route displayed on the results list. Business rule #3: selecting the Route Link (underlined route indicated) will return additional flight information as a separate infowindow. Business rule #4: User action of selecting one of the carrier's fares, displays a single route view, with connections. The user can easily see the entire route 52 on the map 54 with system-generated route lines and location markers.

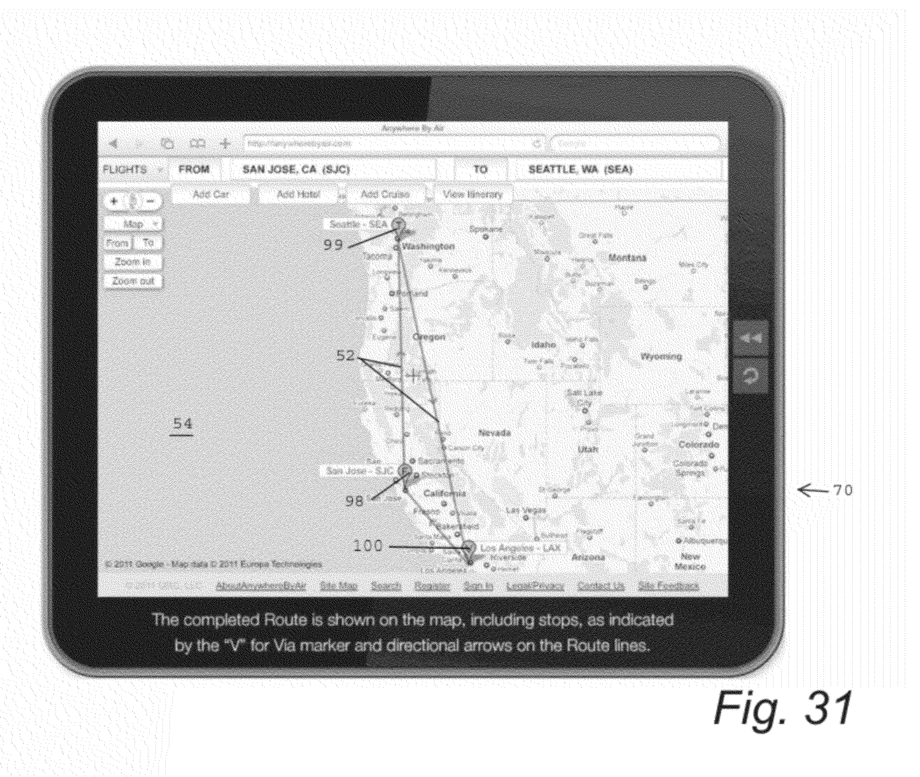

As shown in FIGS. 30 and 31, once the user is satisfied by the results, selecting “Submit” 118 causes the system to display the route(s) 52 on the map 54 and produces a trip plan. The user can either view/book their itinerary or add a car, hotel or cruise reservation to their plan.

### XVI. Adding Ancillary Services

The system 2 can generate information based upon information input by the user on the front end 70 component. This includes adding hotels, rental cars, and other ancillary services to a user's travel plans based upon their flight path and other preferences. Because of limited screen display using touch computers, inference computing requires certain business rules to be made concerning the rental of cars. Business rule #1: if the user has provided the “From” and “To” locations, the only user interaction is the selection of the car based on system-generated criteria. Business rule #2: if the “Car” menu item has been selected and only the “To” marker is displayed on the map, the “Continue Reservations” tab is displayed. Business rule #3: it is not necessary for the “From” marker to be displayed in order to make a car reservation.
The user indicated “To” location is the “Pick-up/Drop-off” location of the car as it is assumed the location the user is going “To,” is where he or she will rent a car.
The system will provide a listing of available rental car agencies specific to the “To” location. Pricing and other information will also be made available to the user.
the “Pick-up Date” will occur as the same date as the flight arrival date at the “to” location, as it is assumed the auto will need to be reserved at least upon the arrival date of the flight at the “To” location.
The “Pick-up Time” will occur at the same time at the “To” location as the flight arrival time, as it is assumed the auto will be reserved at least upon the arrival of the flight at the “To” location.
Cancellations or delays may be system posted from the airline reservation system for user awareness.
The “Return Date” will occur as the same date as the flight return date, as it is assumed the auto will be returned on the return flight date.
The “Return Time” will occur one hour prior to the flight return time, as it is assumed the auto will need to be returned prior to time of return. Flight delays may be posted to the reservation system for user/reservationist awareness.
The number of days reserved will be the system-generated difference between the “Return Date” and “Arrive Date.” Pricing will reflect the calculated difference between the “Return Date” and “Arrive Date.” Any changes after the reservation is made will be handled by the car rental agency.
The system will “Indicate All Cars” listing of available rental car agencies specific to the “To” location. Pricing and other information will be made available to the user.

Because of limited screen display on touch computers, inference computing requires certain business rules to be made concerning the rental of hotels. Business rule #4: if the user has provided the “From” and “To” locations, the only user interaction is the selection of the hotel based on system-generated criteria. Business rule #3: if the “Hotels” menu item has been selected and only the “To” marker is displayed on the map, the “Continue Reservations” tab is displayed. Business rule #6: it is not necessary for the “From” marker to be displayed in order to make a hotel reservation.
The user indicated “To” location is the hotel location, as it is assumed the location the user is going “To” is where he or she will need a hotel.
The system will provide a listing of available hotels specific to the “To” location. Pricing and other information will be made available to the user.
the “Hotel Reserved Date” will occur as the same date as the flight arrival date as it is assumed the hotel will need to be reserved at least upon the arrival date of the flight at the “To” location.
the “Hotel Reservation Time” will occur at the same time as the flight arrival time, as it is assumed the hotel will be reserved at least upon the arrival of the flight at the “To” location. Flight delays may be system posted to the hotel reservation system for user awareness.
The hotel “Vacated Date” will occur as the same date as the flight return date, as it is assumed the hotel will be vacated on the return flight date.
The hotel “Vacated Time” will occur three hours prior to the flight return time, as it is assumed the hotel will be vacated prior to time of return.
The “Number of Days Reserved” will be the system-generated difference between the hotels reserved and vacated dates. Pricing will reflect the number of days calculated. Any changes after the reservation is made will be handled by the hotel agency.
The system will “Indicate All Hotels” from the list of available hotel reservation agencies specific to the “To” location. Pricing and other information will be made available to the user.

Because of limited screen display using touch computers, inference computing requires certain business rules be made concerning the Cruise reservations. Business rule #7: If the user has provided the “From” and “To” locations, the only user interaction is the selection of the Cruise based on system-generated criteria. Business rule #8: if the “Cruise” menu item has been selected and only the “To” marker is displayed on the map, the “Continue Reservations” tab is displayed. Business rule #9: it is not necessary for the “From” marker to be displayed in order to make a Cruise reservation.
The user indicated “To” location is the embark location of the Cruise, as it is assumed the location the user is going “To” is where he or she will need to begin the cruise.
The system will provide a listing of available cruise lines specific to the “To” location. Pricing and other information will be made available to the user.
The “Cruise Embark Date” will occur as the same date as the flight arrival date, as it is assumed the Cruise will need to be reserved at least upon the arrival date of the flight at the “To” location.
The “Cruise Embark Time” will occur at the same time as the flight arrival time, as it is assumed the Cruise will be reserved at least upon the arrival of the flight at the “To” location. Flight delays may be system posted to the cruise line reservation system for user awareness.
The “Cruise Debark Date” will occur as the same date as the flight return date, as it is assumed the Cruise will return on the flight date.
The cruise “Debark Time” will occur three hours prior to the flight return time, as it is assumed the cruise will return prior to time of flight return. Flight delays may be posted to the reservation system for user/reservationist awareness.
The “Number of Days Reserved” will be the system-generated difference between the “Cruise Embark Date” and “Cruise Debark Date.” Pricing will reflect the number of days calculated. Any changes after the reservation is made will be handled by the cruise line agency.
The system will “Indicate All Cruise Lines” from the list of available cruise line agencies specific to the “To” location. Pricing and other information will be made available to the user.

### XVII. View Plan/Book Reservation

The traveler can view the travel plans at any time during their session. If the traveler chooses to change the travel plan prior to its being booked, the system will update the plans based on new inputs. Once the traveler is satisfied with their plan, he or she will submit the plan which will send the results to the appropriate booking agency. Confirmation of the booking will be sent to the traveler's email address. The traveler may choose to save the trip plans and map at this point in the process.

It is to be understood that the invention can be embodied in various forms, and is not to be limited to the examples discussed above. The range of components and configurations which can be utilized in the practice of the present invention is virtually unlimited.

Having this described the invention, what is claimed as new and desired to be secured by Letters Patent is:

1. A travel planning method comprising the steps:
providing a first computing system including a processor and storage memory;
providing a back-end administrative system stored onto said first computer system storage memory;
creating a travel information database for storing travel data, and storing said database within said first computer system storage memory;
retrieving travel data variables via third party databases and via manual inputs, wherein said travel data includes origin locations and destination locations;
providing a second computing system including a processor, a storage memory, and a graphical user interface (GUI);
accessing with said second computing device said travel data variables stored in said travel information database;
selecting a number of travel data variables using said second computing device;
creating a travel route based upon said travel data variables selected using said second computing device; and
creating a digital map displaying said travel route, including the chosen origin location and a connected destination location.

2. The method of claim 1, wherein said travel data variables are comprised of flight data variables, including flight schedules for pre-selected airlines.

3. The method of claim 2, further comprising the steps:
reporting flight variables to said second computing device; and
creating a purchase form on said second computing device whereby airline tickets may be purchased, wherein said airline tickets correspond with said flight selected based upon said flight data variables.

4. The method of claim 3, further comprising the steps:
retrieving information on car rental businesses located near said flight destinations, including car rental company name, vehicle availability, and price; and
reporting said car rental information to said second computing device.

5. The method of claim 4, wherein a vehicle rental purchase may be completed in conjunction with a purchase of said airline tickets.

6. The method of claim 3, further comprising the steps:
retrieving information on lodging located near said flight destinations, including lodging company name, room availability, and price; and
reporting said lodging information to said second computing device.

7. The method of claim 6, wherein a lodging purchase may be completed in conjunction with a purchase of said airline tickets.

8. The method of claim 3, further comprising the steps:
retrieving information on entertainment events located near said flight destinations, including venue name, event name, ticket availability, and price; and
reporting said entertainment information to said second second device.

9. The method of claim 8, wherein a purchase of a ticket to said entertainment event may be completed in conjunction with a purchase of said airline tickets.

10. The method of claim 2, wherein said back-end administrative system compiles a hierarchy of flight data variables, the method further comprising the steps:
compiling said flight data variables by geographic location;
further compiling said flight data variables by airline;
further compiling said flight data variables by airport;
further compiling said flight data variables by available destinations;
further compiling said flight data variables by available connection flights;
further compiling said flight data variables by flight schedule; and
providing access to said compiled flight data variables to said second computing device.

11. A trip planning method comprising the steps:
providing a first computing system including a processor and storage memory;
providing a back-end administrative system stored onto said first computer system storage memory;
creating a flight information database for storing travel data, and storing said database within said first computer system storage memory;
compiling said flight information database from a plurality of flight data variables;
retrieving said flight data variables via third party databases and via manual inputs, wherein said flight data variables include an origin location;
providing a second computing system including a processor, a storage memory, and a graphical user interface (GUI);
accessing with said second computing device said flight data variables stored in said flight information database;
selecting a number of flight data variables using said second computing device;
creating a flight route based upon said flight data variables selected using said second computing device;
creating a digital map displaying said flight route, including said origin location and all possible destination locations;
selecting a destination location from said possible destination locations using said second computing device;
reporting flight variables to said second computing device;
creating a purchase form on said second computing device whereby airline tickets may be purchased, wherein said airline tickets correspond with said flight created from said flight data variables; and
providing ancillary travel service information to said second computing device, whereby said ancillary travel service information is based upon said selected destination location.

12. The method of claim 11, wherein said flight data variables include one or more of the list comprising:
geographic location of origin location, airline name, airline code, airport name, airport code, geographic location of available destination locations, available connection flights, and flight schedule.

13. A travel planning system comprising:
a first computing device including a processor and storage memory;
a second computing device including a processor, a storage memory, and a graphical user interface (GUI);
a database containing travel information stored onto said first computing device storage memory and accessible by said second computing device;
said travel information further comprising a plurality of travel variables, including at least an origin geographic location;
wherein said second computing device is capable of selecting a number of said travel variables;
wherein said second computing device is further capable of producing a travel route based upon said selected travel variables; and
wherein said second computing device is further capable of generating a digital map displaying said travel route, including the chosen origin location and all connected destination locations.

14. The system of claim 13, wherein said travel data variables are comprised of flight data variables, including flight schedules for pre-selected airlines.

15. The system of claim 14, further comprising:
a purchase form being generated on said second computing device, whereby airline tickets may be purchased; and
wherein said airline tickets correspond with said flight selected based upon said flight data variables.

16. The system of claim 15, further comprising:
said second computing device adapted to provide an information window to said GUI, wherein said information window includes information on car rental businesses located near said flight destinations, including car rental company name, vehicle availability, and price; and
wherein a vehicle rental purchase may be completed in conjunction with a purchase of said airline ticket.

17. The system of claim 15, further comprising:
said second computing device adapted to provide an information window to said GUI, wherein said information window includes information on lodging located near said flight destinations, including lodging company name, room vacancy, and price; and
wherein a lodging reservation purchase may be completed in conjunction with a purchase of said airline ticket.

18. The system of claim 15, further comprising:
said second computing device adapted to provide an information window to said GUI, wherein said information window includes information on entertainment events and venues located near said flight destinations, including venue name, event name, ticket availability, and price; and
wherein an entertainment ticket purchase may be completed in conjunction with a purchase of said airline ticket.
